(19) United States
(12) Patent Application Publication
(10) Pub. No.: US 2014/0108496 A1
(43) Pub. Date: Apr. 17, 2014

(54) SYSTEMS AND METHODS FOR BROWSER REDIRECTION AND NAVIGATION CONTROL

(71) Applicant: BROWSIUM, INC., Redmond, WA (US)

(72) Inventors: Matthew HELLER, Washington, DC (US); Matthew CROWLEY, Parma, OH (US)

(73) Assignee: Browsium, Inc., Redmond, WA (US)

(21) Appl. No.: 13/650,012

(22) Filed: Oct. 11, 2012

(51) Int. Cl. G06F 15/16

(52) U.S. Cl. 709/203

(57) ABSTRACT

Methods and systems for redirecting browser navigation are disclosed. A method controls navigation by monitoring and intercepting requests to navigate to content from a browser. The method evaluates the requested content against rules to determine if the content is to be displayed in a specified, different browser. Upon determining that the requested content matches at least one rule, the method redirects the navigation to the specified browser in accordance with the matching rule(s). The method displays the content in the specified browser. A system for controlling navigation to content requested in a browser application includes an administrative user interface (UI) for creating and managing navigation rules. The system also comprises a browser controller for monitoring content requests in a browser, a rules engine for comparing the requested content to the rules and a controller engine for redirecting the navigation to a browser specified in applicable rules using a browser controller.

### FIELD OF THE DISCLOSURE

The present disclosure relates generally to network browsers, and more particularly to redirecting browser navigation or requests for content, web pages, files, or web-based applications, to a particular browser capable of rendering the requested content based upon rules and the requested content.

Web (or Internet) browsers are software applications that retrieve, comprehend and locate information resources (i.e., content) on a network such as the World Wide Web. Information resources are identified by a uniform resource identifier (URI), a sub-category of which is a uniform resource locator (URL). The information resource or content might be a webpage, an image, a video, a browser-based software application (e.g., a web application) or other piece of content. Although browsers are primarily intended to access network resources and content such as multimedia files, web sites and web applications, they can also be used to access information and files provided by servers and private networks or files in a file system. Some browsers can be used to save information resources in file systems. Examples of more common browsers include MICROSOFT™ Internet Explorer (IE), Mozilla Firefox, Chrome from Google Inc., Safari from Apple Inc., and OPERA™ from Opera Software ASA.

A web browser process begins when the user inputs a Uniform Resource Identifier (URI), for example, <http://en.example.com/>, into the browser. The prefix of the URI determines how the URI will be interpreted, e.g., “http:”, which identifies a resource to be retrieved over the Hypertext Transfer Protocol (HTTP). Other protocol prefixes include, e.g., https: for HTTPS (HTTP secure), ftp: for the File Transfer Protocol, and file: for local files. Prefixes that the web browser cannot directly handle (e.g., “mailto:” and “news:” URIs) are often handed off to another application entirely (e.g., the default e-mail application for the enterprise or the enterprise's default newsgroup reader).

In the case of http, https, file, and others, once the resource has been retrieved the web browser will display it. HyperText Markup Language (HTML) code is passed to the browser's layout engine to be transformed from markup to an interactive document. Aside from HTML, web browsers can generally display any kind of content that can be part of a webpage. Most browsers can display images, audio, video, and Extensible Markup Language (XML) documents or files, and often have plug-ins such as Flash applications and Java applets, for example. Upon encountering a file of an unsupported type or a file that is set up to be downloaded rather than displayed, the browser often prompts the user to save the file to disk or identify a program that can open it.

Interactivity in a webpage can also be supplied by JavaScript or other scripting languages such as, but not limited to, Visual Basic Scripting Edition (VBScript), which usually does not require a plug-in. JavaScript can be used along with other technologies to allow ‘live’ interaction with the webpage's server via Asynchronous JavaScript and XML (AJAX). In the most advanced browsers, JavaScript programs can produce interactive 2D graphics using the canvas application programming interface (API) and fully rendered 3D graphics using the Web-based Graphics Library (WebGL).

Information resources may contain hyperlinks to other information resources. Each link contains the URI of a resource to go to. When a link is clicked, the browser navigates to the resource indicated by the link's target URI, and the process of bringing content to the user begins again.

Many organizations would like to control browser software and browser sessions within their network or that can be used to access content in their enterprise systems. For instance, many organizations and entities have a ‘standard’ or default browser installed on client machines and devices with a standard platform or operating system (OS) in their enterprise and periodically update the standard browser platform. Enterprises running virtual machines (VMs) may also run their standard OS and browser on the VMs. Periodic updates of the standard platform can include installation of new, replacement versions of the browser and automated, scheduled, or manual maintenance, such as applying OS and browser security patches, installing plug-in updates, and browser vendor updates, for the standard browser. As a result, these organizations would like to redirect navigation for certain (or all) content from non-standard browsers to their standard browser platform. For example, in a company that uses Internet Explorer (IE) 9 and MICROSOFT™ Windows® 7 as their standard enterprise browser platform, the company would like to redirect navigation requests for certain content and/or URIs from non-standard (in this case, non-IE) browsers such as Mozilla Firefox to their standard IE browser.

Accordingly, there is a need for a configurable navigation redirector for applications and browsers installed on clients in a network. This need is particularly acute in an enterprise network setting where content requests originate from enterprise applications, browsers, and other applications on clients in the network.

### SUMMARY OF THE DISCLOSURE

Embodiments disclosed herein provide architecture with an administrative process including an administrative UI for configuring browser redirection rules and a controller process comprising rules and controller engines, and browser controllers with server transport modules to control navigation of browser processes in an enterprise. The architecture includes configurable redirector process to control redirection and navigation for browsers installed on computing devices and VMs, which can be installed locally on a client computing device that navigation to requested content originated from or on a remote, network-accessible computing device such as a server or another client.

In certain embodiments, a system controls browser redirection and navigation using a controller engine with a series of plugins for various browsers across multiple platforms. The system includes an administrative interface enabling system administrators to create and manage rules to direct attempted navigation to certain content based on, for example, properties of a requested document, properties of a requested web application, and properties of a requested web page such as its domain, protocol, and/or a URI. The system instantiates a rules engine to evaluate rules for content requested in the attempted navigation and assigns a specified browser to display the requested content. The rules engine can work in conjunction with the browser redirection engine to display the requested content in a specific browser application on a specific platform in accordance with defined criteria and rules.

In one embodiment of the system, the controller engine is an Internet browser redirection controller that uses a series of plug-ins for different browsers to enable a system administrator to set up and configure rules for the rules engine. In accordance with this embodiment, the plug-ins can include browser-specific plug-ins for versions of Firefox, MICROSOFT™ Internet Explorer (IE), Chrome, Safari and OPERA™. By using the rules engine to apply one or more rules to requests for specific URIs/URLs/links, Internet domains, web applications and files, the controller can redirect navigation to a specific browser on a specific platform. According to embodiments, the platform can be a physical computing device such as a desktop computer, laptop, tablet device, or server or a virtual machine (VM). For example, rules can be configured to redirect navigation to specified combinations of a browser running on a physical platform such a personal computer (PC) or server running MICROSOFT™ Windows® XP, 7, or 8 and a specific version of IE or a Mac running specific versions of OS X and Safari. Alternatively, rules can be configured and applied to redirect navigation to a VM running a specific, virtualized OS and a browser. The specified VM can be launched on the user's client device or elsewhere on the network.

In accordance with embodiments, a redirection/navigation control process can use rules to switch a browser session to one or more other browsers based on a request to access specific types of information and content such as web applications, files, URIs, and other data objects. Exemplary systems and methods render a user interface (UI) to enable users, such as, but not limited to, system administrators, to create and edit rules for rule-based routing of information or content access requests to a browser to render the requested information, content such as a webpage or application. In embodiments, rules can be used to route or redirect navigation requests to specific browsers (e.g., MICROSOFT™ IE, Mozilla Firefox, OPERA™ from Opera Software, Chrome from Google Inc. or Safari from Apple Inc.) and/or versions of browsers installed locally on a user's client device or available via a network on another computing device or virtual machine (VM). For example, when a browser specified in an applicable navigation rule is not natively installed on a local client device, the specified browser can be launched from a virtualization platform, such as CITRIX™ XenDesktop, XenApp and XenServer, MICROSOFT™ Remote Desktop Services and Terminal Services; VMWARE™ Workstation; and others.

An example scenario addressed by embodiments disclosed herein is provided below.

In an scenario where a network administrator of an organization (e.g., XYZ Inc.) has set Mozilla Firefox as the default or standard browser in the organization's network, users in the network have complained that certain content, e.g., <youtube.com> and <msdn.com>, are sometimes not working as expected when used from inside the default Firefox browser. Using embodiments of the browser navigation control and redirection process disclosed herein, the network administrator can add and deploy two rules in his network that always open <youtube.com> in a Chrome browser and <msdn.com> in a specified IE browser. After these rules are deployed in the XYZ Inc. network, when a user in the network clicks on a link or types an URL that starts with <www.youtube.com> to request content from either of these sites in their default browser (Firefox), a new instance of a redirect browser, such as the Chrome browser from Google Inc., launches <www.youtube.com>. In an embodiment, the Firefox browser still shows the same page that it was showing earlier when the user attempted to navigate to the requested content. The same behavior can be seen while navigating to <www.youtube.com> from Internet Explorer (IE) as well. Otherwise, if a user tries to navigate to <www.youtube.com> in a Chrome browser it completes navigation without any further changes.

In another embodiment, a redirection application and application (e.g., the Catalyst product from Browsium, Inc.) controls browser navigation and redirection in an enterprise using hierarchical set of rules, defined using a an administrator interface of an administrator process. According to this embodiment, the administrator process provides tools to redirect an attempted browser navigation by redirecting the navigation to a rule-specified browser based upon the content requested in the navigation. Such content can include web applications, web sites, and documents. Through the use of a sequence of rules that define redirection of attempted navigation to a specific browser-platform combination, an administrator or other user can control browser navigation (i.e., requests for particular content, files, web applications, protocols, and/or extensions) that overlap with multiple redirection rules. If no rules apply to an attempted navigation or a content request is otherwise incompatible with defined rules, default settings or other criteria can be used to control navigation. In accordance with an embodiment, the system manages the way a natively installed browser navigates to content and when invoked automatically by a rule, the system ensures that web applications are loaded and invoked with the desired browser platform, which can encompass a specific version of a particular browser and the OS of a client machine (physical or virtual) the browser is to be run on. This is all done without modifying current installations on client machines or reducing the security posture of the system.

An exemplary browser-switching architecture and application is a technical solution that provides web application continuity. This architecture and application can enable both individual users and enterprises, such as, but not limited to, businesses, governmental organizations, non-profit groups, universities and other entities, to direct specific web applications to specific web browsers, allowing tighter integration for application workflows, easing side-by-side web browser installation scenarios, and ensuring the integrity of web applications over time.

Yet another embodiment provides a solution that ensures that web application continuity can be assured across an enterprise into the future. Web application continuity provides solutions to control and manage access to web applications regardless of the underlying browser used to initially request the applications. While web-based applications may be built to serve businesses for years including websites and enterprise software, the rate of browser innovation and introduction of new browsers has accelerated to the point it outpaces the standard IT technology system lifecycle.

Depending on implementation, embodiments disclosed herein can decouple the browser/web application dependency as it is understood today. Instead, exemplary embodiments enable individuals and organizations to deploy technologies when appropriate or desirable without necessarily breaking existing lines of business applications or disabling the proper views of web pages developed for specific browsers, such as predecessor browser technologies. Also, dependent upon the exemplary implementations, the present redirection and navigation controller can appear seamless to users insofar as it may be integrated into browsers natively installed on client machines/devices and centrally managed using an administrator process and virtualization solutions.

### BRIEF DESCRIPTION OF THE DRAWING FIGURES

The accompanying drawings, which are incorporated herein and form part of the specification, illustrate exemplary embodiments of the present disclosure and, together with the description, further serve to explain principles, aspects and features of the present disclosure. The exemplary embodiments are best understood from the following detailed description when read in conjunction with the accompanying drawings. It is emphasized that, according to common practice, the various features of the drawings are not to scale. On the contrary, the dimensions of the various features are arbitrarily expanded or reduced for clarity. Included in the drawings are the following figures:

FIG. 1 is a diagram illustrating the system architecture of a client device running a browser application interconnected with a website, in accordance with an exemplary embodiment of the present disclosure.

FIG. 2 is a diagram illustrating the system architecture of a browser navigation and redirection controller interconnected with disparate browser processes, in accordance with an exemplary embodiment of the present disclosure.

FIGS. 3-5 depict a graphical user interface (GUI) for a rules manager for the presently disclosed browser redirection and navigation control system, in accordance with exemplary embodiments of the present disclosure.

FIG. 6 is an architecture diagram of the exemplary browser application shown in FIG. 1.

FIGS. 7 and 8 are flowcharts embodying methods for controlling navigation of a browser application running on a client device to redirect the navigation to alternative browser applications and platforms, in accordance with exemplary embodiments of the present disclosure.

FIGS. 9-11 depict an administrative GUI for configuration management of the presently disclosed browser redirection and navigation control system, in accordance with exemplary embodiments of the present disclosure.

FIG. 12 is a diagram of an exemplary computer system in which embodiments of the present disclosure can be implemented.

### DETAILED DESCRIPTION

Embodiments disclosed herein represent next-generation web application continuity solutions. One exemplary embodiment is the Catalyst product from Browsium, Inc. Certain embodiments allow both individual users and enterprises to direct specific web applications to specific web browsers, allowing tighter integration for application workflows, easing side-by-side web browser installation scenarios, and ensuring the integrity of web applications over time.

The following paragraphs provide information on how certain embodiments can operate and describe exemplary features.

General Overview

An exemplary embodiment provides system administrators control over web application access in a heterogeneous browser environment.

Administrators can define a set of rules that route access of web content (via URIs) to a specific web browser. These rules can be enforced both inside and outside of web browsers due to the fact that content requests can be routed from a wide variety of enterprise applications, from browsers such as Internet Explorer, to MICROSOFT™ Windows® Explorer, to database applications such as Oracle and MICROSOFT™ SQL Server, to email client applications such as MICROSOFT™ Office Outlook. Non limiting examples of such enterprise applications include word processing applications, spreadsheet applications, database applications, e-mail applications and other applications capable of displaying selectable hyperlinks or other actionable references to content.

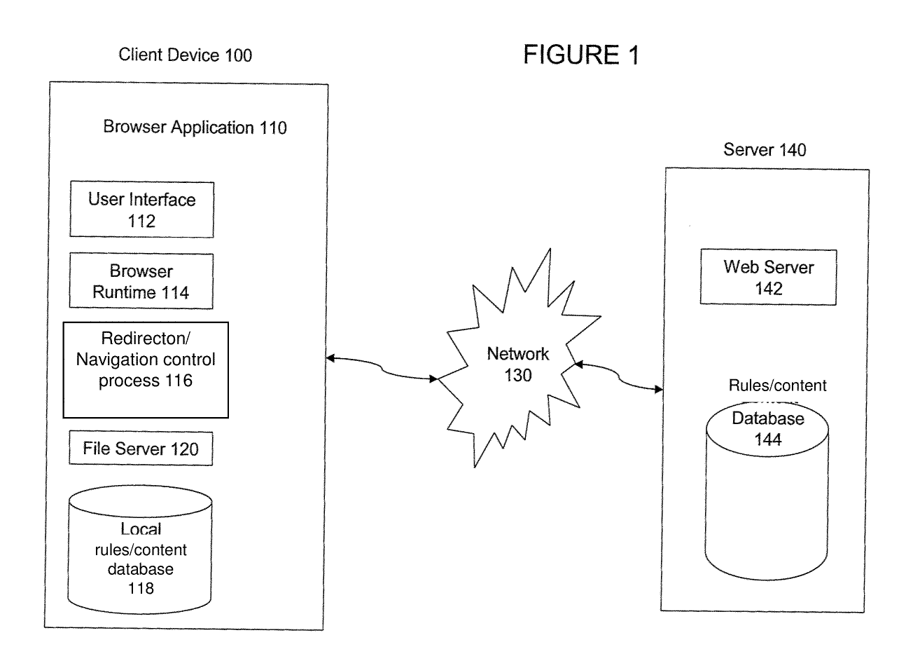

The following paragraphs provide a general overview of certain embodiments, including potential user experience, application workflow, and features with reference to the exemplary components shown in FIGS. 1-3 and 9-11.

Exemplary System Administrator Experience

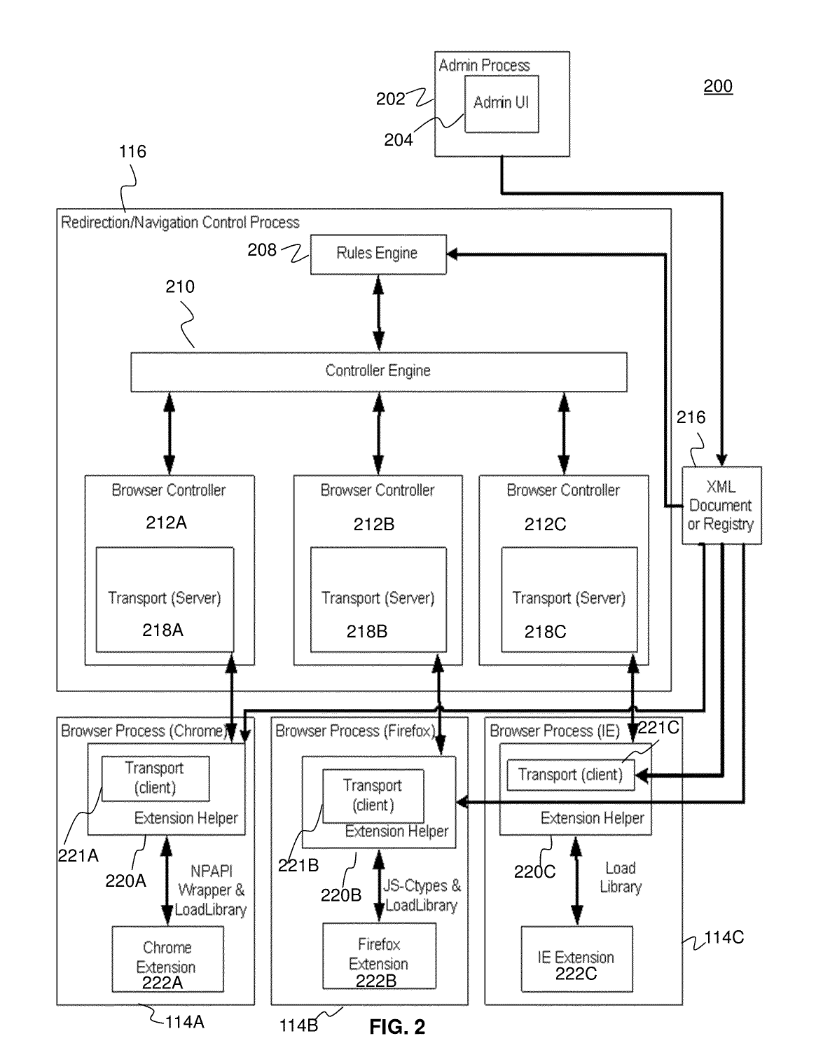

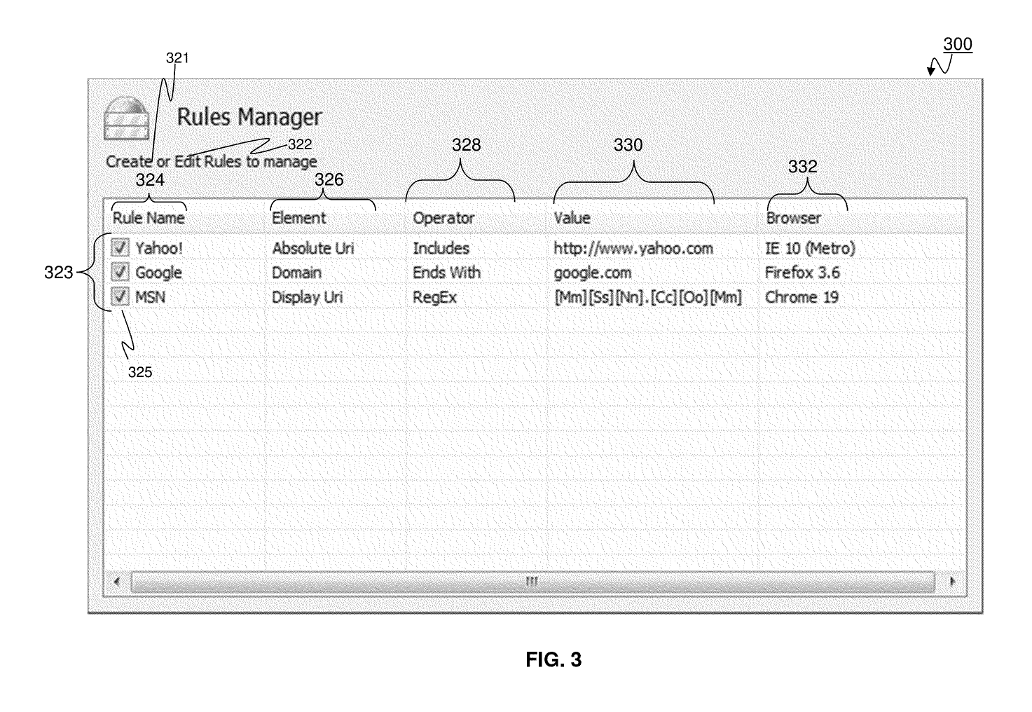

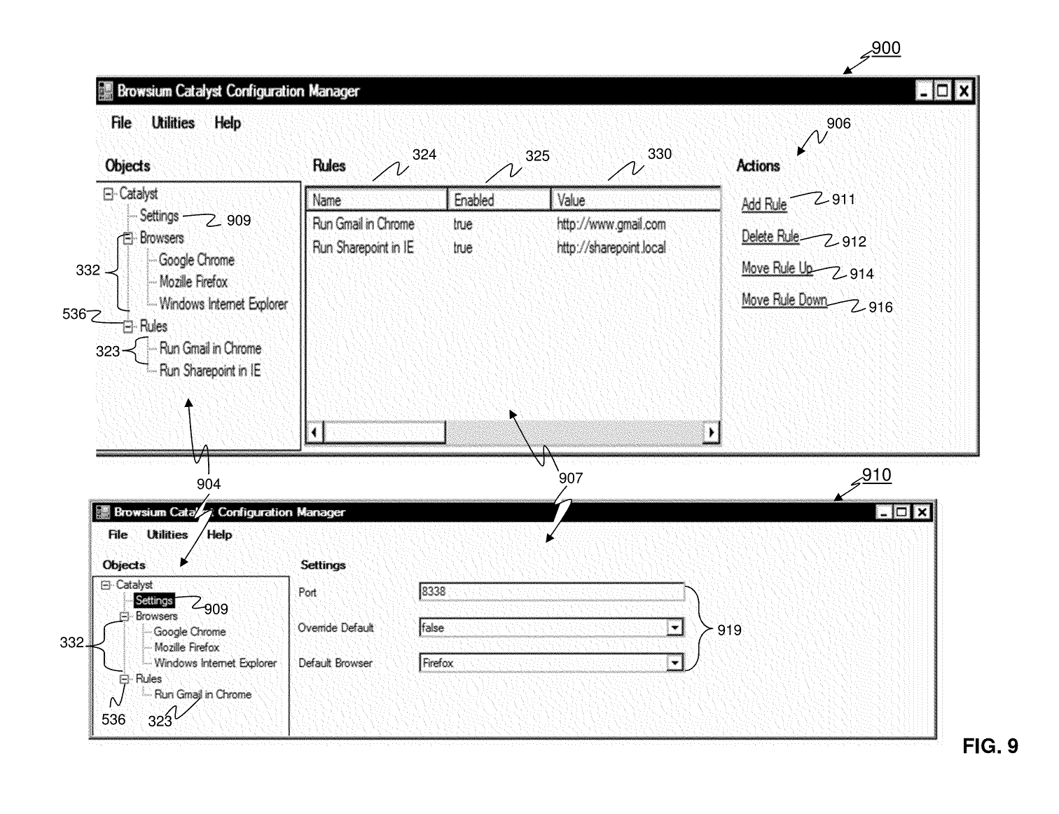

The user interface from the perspective of a system administrator can be simple. An exemplary administration process and UI (see, e.g., the administrative process and UI 202 and 204 of FIG. 2) can include a rules manager such as the exemplary rules manager 300 depicted in FIGS. 3-5 and a configuration manager such as the Browsium Catalyst configuration manager 900 shown in FIGS. 9-11. Other example configuration managers are described in U.S. Provisional Application No. 61/452,490 entitled “Methods and Apparatus for One Browser to Use Rendering Engine of Another Browser for Displaying Information,” filed Mar. 14, 2011 and International Patent Application No. PCT/US2012/29031 entitled “Methods and Systems for One Browser Version to Use a Rendering Engine of Another Browser Version for Displaying Information,” filed Mar. 14, 2012. These prior applications are incorporated herein in their entireties. By using a rules manager, administrators can create, edit, and maintain a set of rules that tie certain attempted navigations and content requests, such as requests to navigate to certain files, webpages, web applications, or other network resources, to certain browsers.

In accordance with embodiments, a rule set can also tie content requests and/or browsers to certain platforms. For example, a rule to display a particular, permitted content request to the Safari browser from Apple Inc. will redirect navigation to an instance of the Safari browser application and can also direct the Safari browser runtime process (see the browser runtime process 114 shown in FIG. 1) to execute on a Mac OS X or iOS platform such as an iPad™, MacBook, iMac, or Mac Pro. Also, for example, a defined rule to redirect navigation for a requested web application to the Chrome browser from Google Inc. can redirect navigation to a Chrome browser runtime process, which can be the browser runtime process 114 shown in FIG. 1, running on a Google Chrome OS or the Chromium OS. Similarly, an administrator can define a rule to redirect navigation for specified content to be displayed in a MICROSOFT™ IE browser process 114 executing on a platform running a MICROSOFT™ Windows® OS such as Windows® XP, 7, 8, or their replacements. As will be appreciated by persons skilled in the relevant art, such redirection platforms can be hosted on a physical computing device external to a client device (see client device 100 in FIG. 1) that the content request originated from. For example, target redirection platforms can be physical computing devices can be a server such as server 140 shown in FIG. 1 or another client device 100 accessible via a network, such as network 130 shown in FIG. 1, or the Internet. In another embodiment, redirection platforms can be virtual machines (VMs) running the target operating system (OS). For example, a redirection platform can be a particular browser application (see browser application 110 in FIG. 1) running on a virtual machine (VM) either locally on the client device 100 where the content request originated from or on a remote computing device such as a server 140. According to an embodiment, rules can indicate a specific redirection platform, such as a local VM, or a physical or VM platform on a network-accessible server 140. If a specific redirection platform is a VM, rules can specify that the VM is to be booted/started and the specified browser launched on the VM as needed. The VM can be started either locally on the client device 100 or on a remote client device 100 or server 140. According to an embodiment, the rules can specify a particular machine (physical or virtual) the redirection platform is hosted on.

As will be appreciated by persons skilled in the relevant art(s), a VM is a software implementation of a computing device such as a server 140, a client device 100, or any other PC, mobile computing device, or computing device that supports the execution of an OS and executes browsers, enterprise applications, and other applications as a physical computing device running that OS would. According to embodiments disclosed herein, a VM can execute an enterprise's standard OS and default browser, or other operating systems and browsers. A VM uses software to duplicate the functionality of a physical computing device that is implemented in hardware and software. Software applications and the OS running on a VM are limited to the resources and abstractions provided by the VM. VMs can be accessible and viewable within an overall virtual infrastructure. As will be appreciated by those skilled in the relevant art, a virtual machine monitor/manager (VMM) or hypervisor can be used by a system or network administrator to start up, monitor, and manage VMs. Such hypervisors can be, but are not limited to VMMs such as the VMWARE™ Player, MICROSOFT™ VirtualPC, SUN™ VirtualBox, VMWARE™ ESX/ESXi, MICROSOFT™ Hyper-V, CITRIX™ XenServer, PARALLELS™, and others. As it would be apparent to one of skill in the art, other hypervisors and VMs/virtualization solutions can be used to configure and access VM platforms specified by redirection and navigation rules as well.

According to an embodiment, the browser processes include respective extension helpers with client transport modules and browser-specific extensions for browsers such as, but not limited to, Mozilla Firefox, Chrome, Safari, OPERA™, IE 8, IE 9, and their replacements. Though exemplary embodiments are discussed herein with reference to IE, Chrome, and Mozilla Firefox browsers, it is to be understood that the need for navigation and redirection control need exists for all browsers, such as, but not limited to, Safari and OPERA™.

A sequence of rules can also represent a hierarchy or prioritized list of specified browser application and platform preferences to handle scenarios where redirection to a specific browser/platform combination may be unavailable. In accordance with embodiments, rules controlling navigation via browser and/or platform redirection can be executed in order by a rules engine (see rules engine 208 of FIG. 2) and the order and can be set by an administrator based on a desired sequence, prioritization, and/or hierarchy.

Exemplary End-User Experience

The user experience of an exemplary navigation control application can be minimal, yet effective. System administrators can use a manager application that contains an interface or panel used for creating and editing settings and rules for a redirection/navigation control application (see, e.g., FIGS. 3-5 and 9-11). End users may experience no direct indication in their user interface that the browser redirection/navigation application executing; the only experience a user may have is that of the browser ‘switching’ that occurs between their current web browser (i.e., the originating application or starting browser) to a specified browser application based on the rule or rules being enforced.

An exemplary end-user experience is simple in that no UI is exposed to the user; rather an application is the background on the system in the form of a controller service and within each browser installed on the system in the form of a plugin or extension for that browser (see, e.g., browser extensions 222 in FIG. 2).

According to an embodiment, when a URL or URI is ‘hit’ or requested within a browser, each browser plugin communicates with the controller. The controller can evaluate the rules and return instructions back to the plugins. If a URL or URI matches a page to be opened in another browser, the plugin in the source browser cancels the action and the URL opening is sent to another browser.

The following features/concepts can be part of an exemplary end-user experience:

1) The user interface such as the user interface 112 shown in FIG. 1 works when a user, using a browser runtime process 114, browses to a given site and the browser specified by the applicable redirection rules loads. This may be in a separate window for a new browser runtime process 114 or appear as a new tab within a current browser application 110.

2) It does not matter if a user requests content by clicking a link in an enterprise application such as an email client (e.g., MICROSOFT™ Outlook) or by opening a favorite/bookmark, clicking a link, or entering a URL manually within a browser application 110.

3) When a user hits or requests content such as a web site, web application, or file governed by a defined rule, the current browser tab or window can stay on the page the user has loaded and then a new browser application opens to render the requested content. In embodiments, the current browser tab can be conceptualized as an originating browser application 110 that a navigation request originated from and the new browser application is a different, specified browser application 110 that the navigation is redirected to in accordance with one or more defined rules.

4) The user should not see a new/blank page/tab in the ‘current’ runtime browser process 114; it should remain on the page it was on the client device 100.

5) Once switched to the new, specified browser application 110, the user should be passed back to their default browser.

The following features and concepts represent a general view of an exemplary feature list:

1) Administrators (e.g., system administrators for an enterprise) can specify that links from a specific enterprise application (e.g., MICROSOFT™ Outlook) must open in a specific browser application 110.

2) Administrators have an option to specify a standard, default browser application 110 for client devices 100 associated with an organization or accessing enterprise applications via an enterprise network 130. A default browser application 110 can be set via installer flag.

3) Administrator option to permit users to use a Flexible Modeling System Runtime Environment (FRE) to choose their default browser application 110.

4) Administrator option to choose ‘close browser tab/window’ on browser switchover from an originating browser application 110 to a browser application specified by applicable redirection rules and/or criteria.

5) Administrator option to choose ‘block user navigation’ for a rule match so that requests to navigate to certain, prohibited content are terminated/aborted.

6) Administrator option to choose ‘execute command/application’ for a rule match.

7) Administrator option to specify arguments to pass to a new, specified browser application (e.g., any possible parameters, launch flags, etc.).

8) Installer for the redirection/navigation control process 116 should support browsers not yet installed. For example, if Mozilla Firefox is not installed when the redirection/navigation control process 116 or its associated application is installed, a plug-in will work with Firefox when it is subsequently installed.

9) Ability to specify opening redirected navigation to content such as browser link in a new tab, window, or session of a browser application 110.

Exemplary System Features

Exemplary embodiments can support a wide variety of operating system versions, web browser offerings and versions, and enterprise functionality, such as, for example, MICROSOFT™-based enterprise functionality.

Embodiments support IE versions 8, 9, 10 and their replacements, Chrome versions 18, 19 and their replacements, Firefox versions through 3.6 and their replacements, OPERA™, and Safari. As shown in FIG. 3, an embodiment includes a simple administrative interface to create rules for redirecting and controlling navigation to content, including, but not limited to, web pages served by a web server, web applications, flat files, multimedia files, and other files.

Browser Redirection and Navigation Control Architectures

FIG. 1 is a diagram illustrating an exemplary system architectures of a client device running a browser application interconnected with a website. The client device 100 shown in FIG. 1 is any computing device that can receive user input and can transmit and receive data via a network. Client devices 100 can include, but are not limited to, a desktop computer, a laptop computer, a netbook computer, a Personal Digital Assistant (PDA), a tablet computing device, an iPhone™, an iPod™, an iPad™, a device operating the Android operating system (OS) from Google Inc., a device running the MICROSOFT™ Windows® Mobile OS, a device running the MICROSOFT™ Windows® Phone OS, a device running the Symbian OS, a device running the webOS from Hewlett Packard, Inc., a mobile phone, a BlackBerry® device, a smartphone, a hand held computer, a palmtop computer, an ultra-mobile PC, or nearly any other device having computing functionality and data communication capabilities. As illustrated in FIG. 1, the client device 100 communicates via a network 130. The network 130 is to be broadly construed to include any combination of local area and/or wide area networks using both wired and wireless communications. Additionally, the browser application 110 of the client device 100 can be used for accessing local content database 118 through a file server 120, for instance.

Unless specifically stated differently, in an embodiment, a user and administrator are interchangeably used herein to identify a human user, a software agent, or a group of users and/or software agents. Besides a human user or system administrator who may need to redirect and control navigation to content, a software application or agent sometimes need to invoke, apply, and configure navigation rules for redirecting and controlling navigation to content such as web pages, web applications, and files. Accordingly, unless specifically stated, the terms user and administrator as used herein do not necessarily pertain to a human being.

When the client device 100 communicates over the network 130, it generally communicates with web servers linked to a website hosted by a server. As illustrated in FIG. 1, a web server 142 of a server 140 on a network 130 is in communication with a rules and content database 144. While only one rules and content database 144 is shown in FIG. 1, it is to be understood that there could be many more data stores or databases, including separate databases for rules and content, hosted either locally on the server 140 or on external database servers. The web server 142 can serve web pages as well as other web-related content such as Java, ADOBE™ Flash, XML and any other protocol or software that is implemented for use in conjunction with the browser application 110, whether or not over a network 130. It is to be understood that the user interface 112 depicted in FIG. 1 is not limited to a design wherein the user interface 112 is a UI for an Internet browser such as IE. For example, in an embodiment, the user interface 112 can be a UI for a first, enterprise application (e.g., ‘application A’) that is capable of displaying selectable hyperlinks to content and utilizes another, second application (e.g., ‘application B’) that interpret network communication for hyperlinks selected in application A, where application B will most commonly be a web browser (e.g., browser application 110) and application A can be any enterprise application capable of receiving requests to navigate to content. For example, application A can be one or more of a word processing application, a graphics application, an email application, or a spreadsheet application and application B can be web browsers such as IE, Firefox, Chrome, OPERA™, and Safari.

The browser application 110 allows the user to retrieve and present information available in resources via the Internet or on a private network (e.g., an Intranet) put through a file server and file server locally. By locally, it is meant that the same computing device (with one or more processors) within a client device 100 with or without peripheral devices connected thereto. The web server 142 might send requested content, such as documents, in a mark-up language such as HTML or XML through the use of a uniform resource locator (URL). The web server 142 also identifies the location of requested content and resources such as webpages, media files, (e.g., image or video) or any other piece of content that might be hosted by a server 140 and/or a web server 142 and requested via a browser application 110.

The browser application 110 has a user interface 112 representing information of the user as well as allowing the user to provide input, such as data or requests from the user that might be sent to the server 140 or the file server 120. The reply may be a mark up language document comprising information and instructions for rendering an image provided and for taking actions on the client device 100. The browser runtime process 114 parses a mark up language document, renders it for display in the user interface 112, and takes actions based on instructions provided in the mark up language document. In some embodiments, the browser runtime 130 can include a scripting engine for processing instructions provided on a client side scripting engine.

The browser runtime process 114 also allows access to a local storage or data store, such as local rules and content database 118, either directly or through a file server 120. In an embodiment, the local rules and content database 118 includes a plurality of navigation rules for redirecting requests for content in the browser application 110 on the client device 100 to another, non-standard browser and/or platform. In an alternative embodiment, the rules are stored in content In addition to redirection/navigation control rules, local run time data stored in local content database 118 can include content that the redirection rules allow the standard/default browser application 110 to display on the client device 100, such as, but not limited to, web applications (e.g., runtime scripts and code with a local copy of data needed to run the applications), and files such as text documents, images, audio files, video files, and other multimedia files. Such content can include cached copies from a prior session of the browser application 110.

The browser application 110 also includes a browser redirection/navigation control process 116, which is a focus of the present disclosure. Although the browser redirection/navigation control process 116 is shown as being hosted locally on the client device 100 in FIG. 1, it is to be understood that the control process 116 can be hosted on an external server, such as, for example, server 140, or another server within an organization's enterprise that is accessible from the client device 100 via the network 130.

FIG. 2 is a diagram illustrating the system architecture of a browser navigation and redirection controller interconnected with disparate browser processes. FIG. 2 is described with continued reference to the embodiment illustrated in FIG. 1. However, FIG. 1 is not limited to that embodiment. To illustrate the effect of the browser redirection and navigation controller 116, FIG. 2 illustrates architecture 200 for a browser redirection and navigation controller that can redirect navigation to a desired browser and/or platform based on rules.

As shown in FIG. 2, architecture 200 includes an administrative process 202 including an administrative UI 204 for configuring browser redirection rules via an XML Document or Registry 216 and the redirection/navigation control process 116. In the exemplary embodiment of FIG. 2, the redirection/navigation control process 116 comprises a rules engine 208, a controller engine 210, and browser controllers 212 having respective server transport modules 218 to control navigation of browser processes 114 in an enterprise. FIG. 2 depicts an embodiment wherein the browser processes 114 include respective extension helpers 220 with client transport modules 221 and browser-specific extensions 222 for browsers such as, but not limited to, Chrome (see, e.g., Chrome extension 222A), Mozilla Firefox (see, e.g., Firefox extension 222B), IE (see, e.g., IE extension 222C), Safari (not shown), OPERA™ (not shown), and their replacements. Though exemplary embodiments are discussed herein with reference to IE, it is to be understood that the need for navigation and redirection control need exists for all browsers, such as, but not limited to Mozilla Firefox, Chrome, Apple Safari, and OPERA™. The components of architecture 200 are described in the following paragraphs.

Redirection/Navigation Control Process

The redirection/navigation control process 116 can be conceptualized as the ‘brain’ of an exemplary browser navigation and redirection controller. According to one embodiment, the redirection/navigation control process 116 can be hosted by and executed on a server 140 external to the client device 100. In the alternative embodiment shown in FIG. 1, the redirection/navigation control process 116 executes locally on the client device 100. In one embodiment, the redirection/navigation control process 116 is a singleton per user session and it starts as soon as browser navigation in a browser application 110 and redirection controller application is enabled for that user. Some of the functions implemented in the redirection/navigation control process 116 are described below.

Controller Engine

According to embodiments, the main states of the browser navigation and redirection controller are maintained in the controller engine 210. In an embodiment, the controller engine 210 as such can be a relatively light weight component as it may not have significant logic other than instantiating different sub components as required and controlling execution of those components. In accordance with embodiments, the controller engine 210 listens to the URL verification requests from various browser runtime processes 114 and decides how to route the URL based on the input from the rules engine 208, which is described below.

Rules Engine

As shown in the exemplary embodiment of FIG. 2, the rules engine 208 can be a component of the redirection/navigation control process 116. In another embodiment, the rules engine 208 can also be part of each instance of the browser processes 114. In one embodiment, when the controller engine 210 initializes the rules engine 208, it reads the rules that were generated by an administrator using the administrative (admin) process 202 and initializes its internal data structures for further processing. In accordance with one non-limiting embodiment, when the controller engine 210 provides the rules engine 208 with a URL, it can provide one of two answers:

1) An indication as to whether content such as a URL needs a new instance of the browser; and

2) A type of browser instance/platform to open the URL with (e.g., a browser process 114A for Chrome, a browser process 114B for Firefox, or a browser process 114C for IE.

These responses can be further fine-tuned as richer rules and settings are integrated into the rules engine 208.

Browser Controllers

The controller engine 210 creates separate instances of the browser controllers 212 for every instance of the browser application that it is monitoring. One exemplary goal of the browser controllers 212 is to maintain the Server state of each browser instance and abstract out the details around managing each browser instance or runtime process 114. Some embodiments do not need browser-dependent implementation of the browser controllers 212. For example, a class for browser-specific browser controllers 212A-C can be derived from a base browser controller 212 for any specialized processing specific for a particular browser process 114.

Server Transport Layer

The server transport layer 218 can abstract out the details of Inter Process Communication from other components in the architecture 200. According to the exemplary embodiment of FIG. 2, only the server part 218 of the transport layer is implemented inside the redirection/navigation control process 116. Each browser controller 212A-C contains its respective instance of a transport channel as server transport layers 218A-C. According to an embodiment, both the server 218 and client portions 221 or pieces of the transport layer can be implemented with a goal of easily replacing it with a different type of transport, as needed. In embodiments, the server transport layers 218 comprises a plurality of server transport modules 218A-C for each browser process 114A-C, which in turn have respective client transport modules 221A-C.

Monitor (not shown, but implemented if required by an enterprise). The monitor subcomponent can run in a separate thread inside the redirection/navigation control process 116 to monitor various processes such as browser processes 114A-C and the health of the plugins and extensions 222A-C running inside those processes.

Browser Processes

Chrome, Firefox and Internet Explorer runtime processes 114A-C are defined as browser processes 114 in the exemplary embodiment illustrated in FIG. 2. In embodiments, each of these browser processes 114A-C have a respective extension 222A-C running inside them that control the navigation of the browser processes 114A-C as required by rules applied by the rules engine 208.

Browser Extensions

According to an embodiment, a separate browser extension 222A-C may be needed for each type of browser running a browser process 114A-C. An exemplary function of the browser extensions 222 would be to trap outgoing HTTP requests sent from the browser processes 114 and check with an extension helper component 220 to verify if the URL needs to be opened in the same instance of the browser or if the navigation should be aborted/terminated due to one or more rules applied by the rules engine 208. In other embodiments, functionality of the browser extensions 222 can be expanded to include settings such as closing the current tab or showing a custom web page as an alternative to aborting or terminating navigation to content such as specific URL or URI.

In accordance with embodiments, each browser extension 222A-C may load and invoke a shared Extension Helper 220 library in a different way than what is allowed by a particular browser extension 222A-C model. Examples of each of the browser extensions 222A-C depicted in FIG. 2 are discussed below.

Chrome Extension 222A

The exemplary Chrome extension 222A shown in FIG. 2 uses a Netscape Plugin Application Programming Interface (NPAPI) based plugin to load and access the Chrome Extension Helper 220A component which can shared across different browsers and browser processes 114. As shown in FIG. 2, the NPAPI-based plugin for the Chrome extension helper 220A can be implemented as NPAPI wrapper and LoadLibrary.

Firefox Extension 222B

An exemplary Firefox extension 222B uses NPAPI-based plugin to load and access the Extension Helper 220B component which can be shared across different browsers implementations.

Internet Explorer Extension 222C

An exemplary IE extension 222C can use a LoadLibrary to directly load an extension helper 220C binary and its associated internal implementations.

Extension Helpers

According to an embodiment, the bulk of common business logic related to each plugin can be implemented inside extension helpers 222. The extension helpers 222 can also instantiate the rules engine 208 to provide input on whether content such as a requested URL needs to load within the same instance of a browser associated with a current browser process 114, or if the navigation needs to be aborted with an alternative action plan. If an alternative action needs to be taken, an extension helper 220 (e.g., 220A) can inform its browser extension 222 (e.g., 222A) of the course of action and message or inform the redirection/navigation control process 116 to evaluate the URL further using the corresponding client transport layer 221 (e.g., 221A). In one embodiment, the course of action is to abort or terminate the URL navigation.

Client Transport Layers

In accordance with an embodiment, client transport layers 221 can abstract out the details of Inter Process Communication from other components of the architecture 200. In one embodiment, only the client part 221 of the transport layer is implemented inside an Extension Helper 220 running inside a given browser process 114.

According to an embodiment, the architecture 200 can also control browser redirection and navigation based upon a combination of rules and the presence of a browser helper object (BHO), which is a DLL module designed as a plug-in for the MICROSOFT™ IE web browser to provide added functionality. If present, BHOs are loaded once by each new instance of IE but can be launched for each browser session (e.g., a browser runtime process 114 for a browser application 110), window or tab. Other examples of BHOs include ADOBE™ ACROBAT™ which allows IE users to read Portable Document Format (PDF) files in their browser.

Example Rules Manager Interface

FIGS. 3-5 illustrates exemplary embodiments of a rules manager that can be rendered on a display console of a server 140 or a display device of another computing device, such as a client device 100. FIG. 3 is described with continued reference to the embodiments illustrated in FIGS. 1 and 2. However, FIG. 3 is not limited to those embodiments.

In embodiments, a client device 100 or a server 140 may include the exemplary rules manager interfaces illustrated in FIGS. 3-5. According to one embodiment, the rules manager interfaces depicted in FIGS. 3-5 are accessed and used by an administrator in the administrative UI 204 on a server 140 to create and manage rules in a rules and content database 144. In another embodiment, a client device 100 running a browser redirection and navigation control process 116 with a local rules and content database 118 may display the exemplary rules manager interfaces illustrated in FIGS. 3-5 as part of the user interface 112.

Throughout FIGS. 3-5 displays are shown with various selectable GUI elements such as hyperlinks (i.e., links), command regions, tabs, buttons, checkboxes, dialog boxes, drop down menus, and data entry fields, which are used to initiate action, invoke routines, enter data, view data, or invoke other functionality, such as creating and editing rules for the rules engine 208 of the browser redirection and navigation controller 116. Some of these GUI elements may be inactive depending on a current context or activity in an interface and/or privileges of a user interacting with the interface. In accordance with embodiments, disabled, inactive GUI elements such as links can be displayed as greyed out or not displayed at all in FIGS. 3-5. For brevity, only the differences occurring within the figures, as compared to previous or subsequent ones of the figures, are described below. By using an input device (not shown) or touch screen on a client device 100 or server 140, an administrator or user can interact with the interface illustrated in FIGS. 3-5 to configure and manage rules for the rules engine 208 of the browser redirection and navigation controller 116.

In an embodiment, the rules manager 300 shown in FIG. 3 is part of the administrative UI 204. The rules manager 300 provides for rules management by an administrator or other user and can used to define rules 323 to be used by the rules engine 208 to control browser redirection and navigation on client devices 100. Settings for conditions or attributes of rules 323 can include designating certain content matching a value 330, such as web-based applications or websites as being suitable for rendering using a particular version of a browser 332 on a particular platform.

As illustrated in the exemplary embodiment of FIG. 3, rules 323 can be given rule names 324 and can be enabled (i.e., activated) or disabled (i.e., deactivated) by selecting or de-selecting a rule checkbox to toggle a set rule field 325. For example, by de-selecting the checkbox in the rules manager 300 next to a rule 323, an administrator sets the set rule field 325 for that rule 323 to ‘Disabled’ and the rule will not be applied to attempted navigations or content requests. Conversely, by selecting or clicking on the checkbox using an input device or touch screen, the set rule field 325 for the rule 323 is set to ‘Enabled’ and the rule 323 will be applied by the rules engine 208 to intercepted and received navigation attempts and content requests.

With continued reference to FIG. 3, operators 328 for rules 323 can contain regular expressions (RegEx), Includes, and ‘Ends With.’ Rules 323 can also include elements 326 for a Domain, ‘Absolute URI,’ or ‘Display URI’ for requested content along with corresponding values 330 for the elements 326. Lastly, each rule 323 can define a browser 332 that navigation is to be directed (or redirected to) when a given element 326, operator 328, and value 330 are satisfied for requested content. In an embodiment, the browser 332 can further specify a redirect platform that the browser 332 is to be launched on, such as, but not limited to a platform running MICROSOFT™ Windows®, OS X, iOS, Chrome, Chromium, or a Linux OS. The redirect platforms can be specific computing devices, such as a specific client device 100 or a server 140 accessible via the network 130.

Alternatively, the redirect platform can be a VM running either locally on the client device 100 where navigation to content originated from, or externally on a network accessible client device 100 or server 140. The VM can be a software implementation of a specified platform for a client device 100 or server 140 that supports the execution of an enterprise's standard OS, browser and enterprise applications as the corresponding physical client device 100 or server 140 running that OS would. Alternatively a VM can be configured execute a non-standard OS and/or browser as needed to provide a platform-browser combination specified by navigation rules. In either case, the VM uses software to duplicate the functionality of a rule-specified physical computing device that is implemented in hardware and software. As would be appreciated by one skilled in the art, browser applications and the OS running on a VM are limited to the resources and abstractions provided by the VM. VMs can be accessible via the network 130 and viewable within an overall virtual infrastructure. As will be appreciated by those skilled in the relevant art, a virtual machine monitor/manager (VMM) or hypervisor can be used by a system or network administrator to start up, monitor, and manage VMs. Such hypervisors can be, but are not limited to VMMs such as the VMWARE™ Player, MICROSOFT™ VirtualPC, SUN™ VirtualBox, VMWARE™ ESX/ESXi, MICROSOFT™ Hyper-V, CITRIX™ XenServer, PARALLELS™, and others. As it would be apparent to one of skill in the art, other hypervisors and VMs/virtualization solutions can be used to configure and access VM platforms specified by redirection and navigation rules as well.

According to an embodiment, the browser processes include respective extension helpers with client transport modules and browser-specific extensions for browsers such as, but not limited to, Mozilla Firefox 3.6, Chrome 18, Chrome 19, Safari, OPERA™, IE 8, IE 9, IE 10, and their replacements. Though exemplary embodiments are discussed herein with reference to IE, Chrome, and Mozilla Firefox browsers, it is to be understood that the need for navigation and redirection control need exists for all browsers, such as, but not limited to, Safari and OPERA™.

An administrator or user can name a rule 323 using any characters without restriction or character count limit. Rule names 324 are for an administrator's use and identification only, and have no impact on functionality.

Exemplary elements 326 are described in Table 1 below, which lists the various elements 326 on which rules 323 can be created.

TABLE 1
Rule Elements

| Type | Description | Example |
|---|---|---|
| Absolute URI | The entire canonical URI, | <http://www.browsium.com>/ |
| | including protocol scheme, | |
| | username, password, | |
| | hostname, domain, port, path, | |
| | query, extension and | |
| | fragment. | |
| Authority | Username, password, | user@host.browsium.com:9001 |
| | hostname, domain and port. | |
| Display URI | The protocol scheme, | <http://www.browsium.com> |
| | hostname, domain, port, path, | |
| | query, and optionally, | |
| | fragment. | |
| Domain | The domain (including top | <browsium.com> |
| | level domain) only. Not for | |
| | use for intranet sites. (Use | |
| | “Host” instead.) | |
| Extension | The file extension of the | .html |
| | requested content or | |
| | resource. | |
| Fragment | The information following a | #top |
| | fragment marker (#), including | |
| | the marker itself. This can | |
| | refer to named anchors found | |
| | within a requested document. | |
| Host | The fully qualified domain | <browsium.com>, a file |
| | name or plain hostname. | store, or data store such as |
| | | a local rules and content |
| | | database 118 or a rules and |
| | | content database 144. |
| Password | The password, as parsed | Password |
| | from the URI. | |
| Path | The path and resource name. | /animals/birds |
| Path and | The path, resource name and | /animals/birds?robin |
| Query | query string. | |
| Query | The query string. (All text | ?robin |
| | following a ? in a URI) | |
| Raw URI | The entire URI as entered, | <http://username:password@hostn%61me.browsium.com> |
| | including characters | |
| | represented as “%61” | |
| Scheme | The protocol scheme name. | http or ftp |
| Name | (The text preceding “://” in an | |
| | URI.) | |
| User Info | The username and password, | user:password |
| | as parsed from the URI. | |
| User Name | The username as parsed | User |
| | from the URI. | |
| Host Type | The type of host. | 2 (IPV4), 3 (IPV6) |
| Port | The port number. | 850 |
| Scheme | The scheme of the URI. | 2 (HTTP), 11 (HTTPS) |
| Zone | The zone of the URI. | 1 (INTRANET), 3 |
| | | (INTERNET)., etc. |

Table 2 below contains a brief explanation of available operators 328 for rules 323.

TABLE 2
Rule Operators

| Condition | Description |
|---|---|
| Is | Exactly matches a value field (e.g., a setting for a |
| | value 330). |
| Is Not | Does not match the value field. |
| Less Than | Is less than and not equal to the value field. This |
| | conditional is especially useful with the Host, Port, |
| | Scheme and Zone rule types. |
| More Than | Is more than and not equal to the value field. This |
| | conditional is especially useful with the Host, Port, |
| | Scheme and Zone rule types. |
| Begins With | Starts with the string in the value field. |
| Ends With | Ends with the string in the value field. |
| Excludes | Does not contain the value field. |
| Includes | Contains the value field. |
| RegEx | Is determined by the regular expression in the |
| | value field. |

In the example shown in FIG. 3, using an input device to interact with a displayed rules manager 300, a system administrator can add a rule 323 that forces content with an element 326 of Absolute URI where the value 330 is the string <http://www.yahoo.com> and the operator 328 is Includes to open up any requested content with a URI including <http://www.yahoo.com> with browser 332 IE 10 Metro. A rule 323 could also be added to ensure that if a value 330 for requested content is a URI where the element 326 is a domain (e.g., the element is Domain) ending with the string <google.com> (e.g., the and the operator 326 is ‘Ends With’), that URI opens up in browser 332 Firefox 3.6. As shown in FIG. 3, a value 330 for content for a rule 323 could be defined for an element 326 of Display URI that is evaluated as a regular expression (e.g., operator 328 is RegEx) so that a match count greater than 0 in the string [Mm][Ss][Nn].[Cc][Oo][Mm] will render the page in the browser 332 Chrome 19.

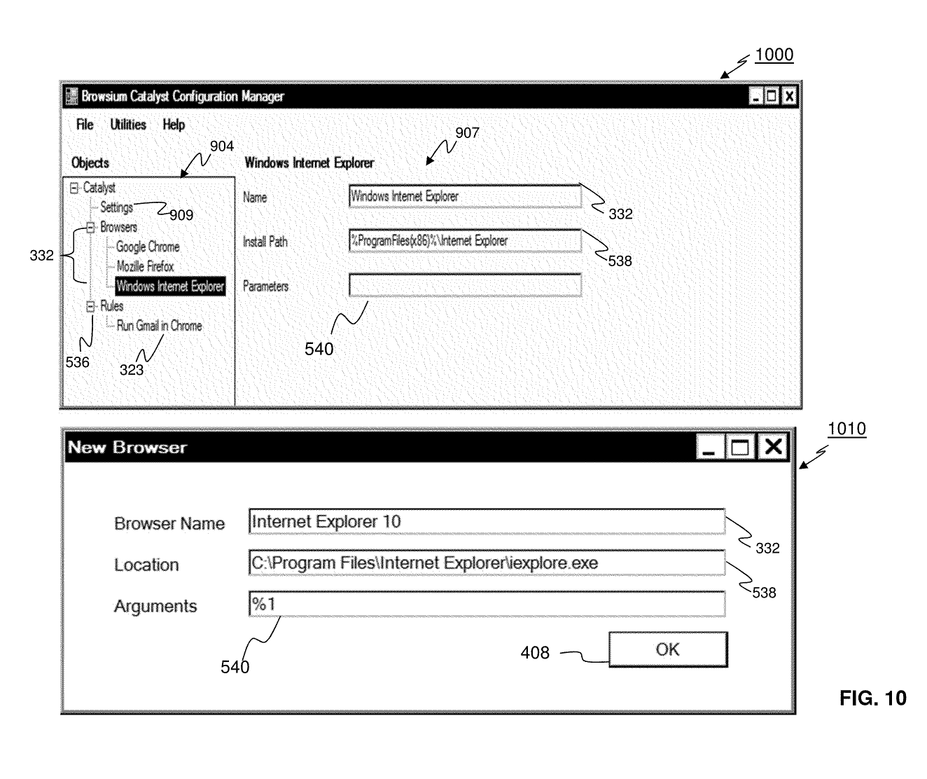

According to embodiments, one or more of displayed names 324, elements 326, operators 328, values 330, and browsers 332 for existing rules 323 are selectable and directly editable within the rules manager 300. For example, an administrator or user can select a browser 332 by double or right clicking via a mouse or pointing input device to cause a drop down menu of available browsers to be displayed. In this example, a new browser 332 can be entered by selecting an ‘Add New Browser’ option from the drop down menu or by typing in a new browser name. In either event, an add new browser interface such as the one described below with reference to FIG. 10 can then be displayed to add a new browser for a given rule 323. Besides drop down menus, selecting the text of one or more of a name 324, element 326, operator 328, value 330 and browser 332 for an existing rule 323 allows an administrator to edit these rules components by typing via a keyboard input device.

The Set Rule data entry field 325—rules 323 are enabled by default when they are created. Enabled rules 323 are displayed in the rules manager 300 with the checkbox for the set rule field 325 indicated as ‘checked’ or selected. Some rules 323 may contain complex parameters or complex paths and it may be more practical to simply disable a rule 323 rather than remove it if the rule 323 is not needed or to test ordering/sequencing, prioritization, or hierarchy patterns. In addition, some users may choose to keep only a single set of rules 323 (e.g., a rule set 536) and want to disable a specific rule 323 for some given period of time. To disable a rule 323, an administrator can select ‘Disabled’ from the drop down list for the set rule field 325 or de-select the checkbox next to the rule 323 name in the rule creator 500. According to an embodiment, de-selecting the checkbox in the rules manager 300 is equivalent to selecting a set rule field 325 of ‘Disabled’ in the rule creator 400 and selecting or clicking on the checkbox is the same as selecting the set rule field 325 to ‘Enabled.’

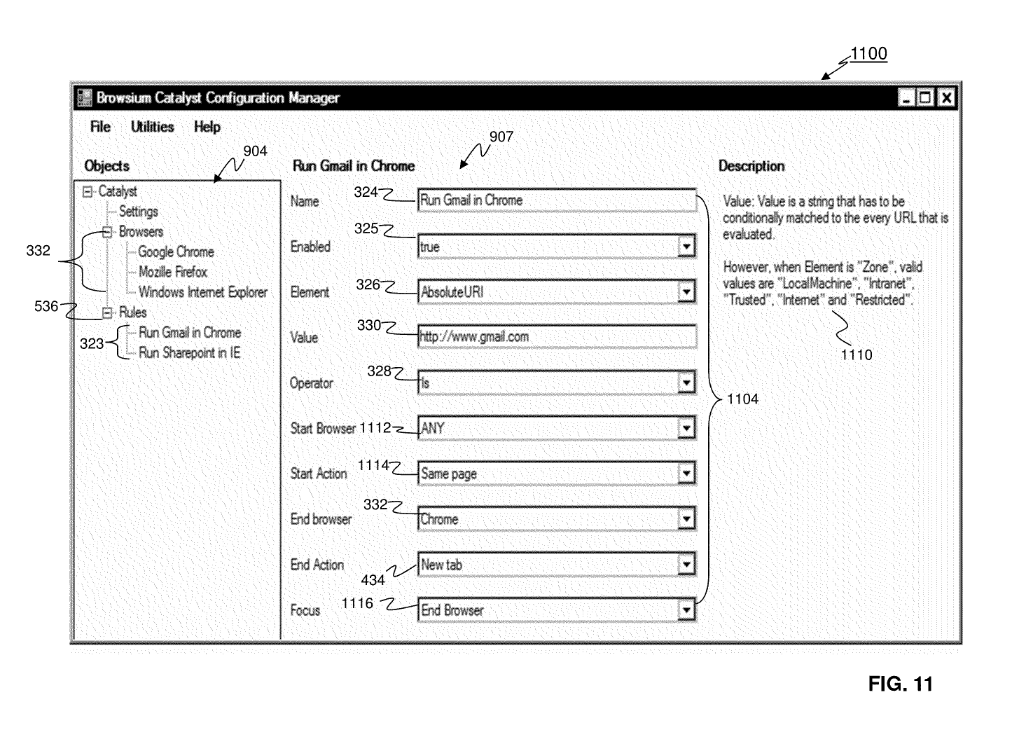

As shown in FIG. 3, the rules manager 300 can also be used to edit an existing rule by selecting an edit rule link 322 to change values in the rule data entry fields 404 or 504 for an existing rule 323. In accordance with an embodiment, a rule editor (see, e.g., rule editor 1100 shown in FIG. 11) can be invoked by clicking the edit rule link 322 in the rules manager 300 in order to revise data entry fields 404 or 504 for an existing rule.

According to the Catalyst embodiment of the browser redirection/navigation control process 116, an administrator or user can create specific file/content rules 323 as well as define browser/platform redirection rules and navigation controls for a rule set. Rules 323 can be edited in the exemplary configuration manager 900 discussed below with reference to FIG. 9. In one embodiment, the redirection/navigation control process 116 supports rules for protocols (e.g., HTTP, HTTPS, and FTP). Any required redirection/navigation rules 323 can be defined using the rules manager 300.

By creating and editing rules 323 using rules manager 300, an administrator or other user can control a browser application by intercepting and redirecting navigation to a requested web application and/or protocol, such as, for example, HTTP, HTTPS and FTP.

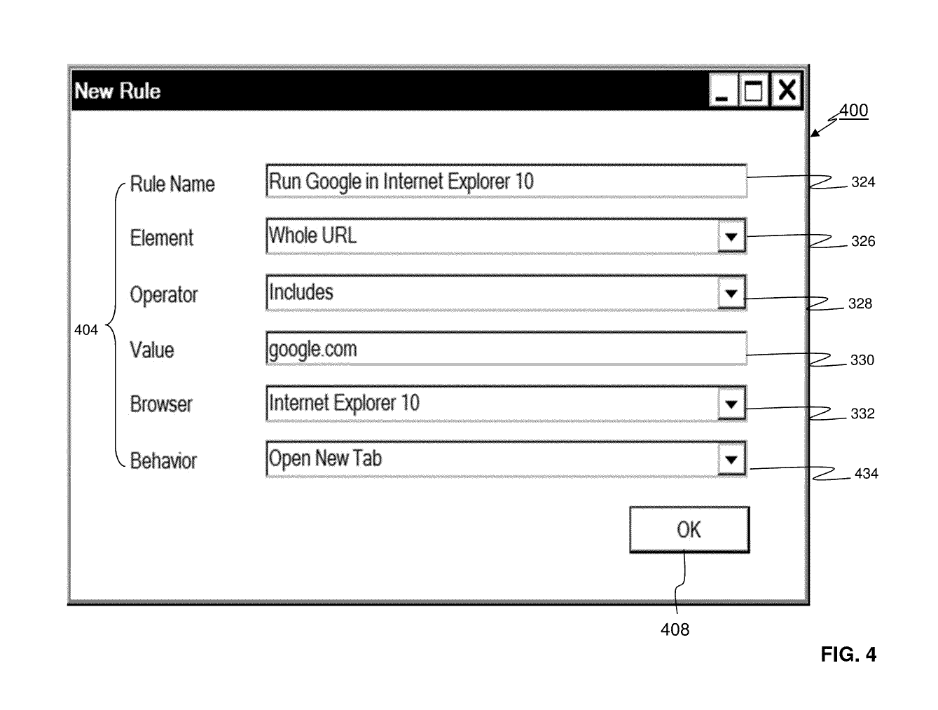

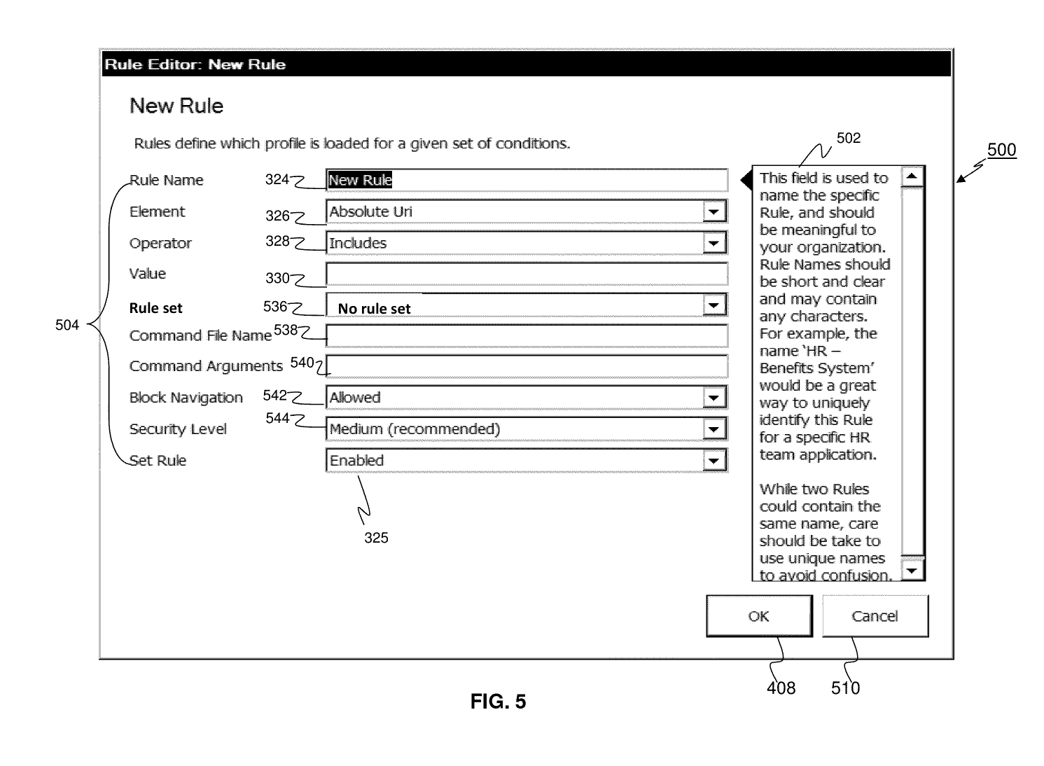

FIGS. 4 and 5 depict exemplary rules creators 400 and 500, respectively. According to embodiments, rules creators 400 and 500 can be accessed from the rules manager 300 interface or a configuration management interface (see, e.g., the configuration manager 900 described below with reference to FIG. 9) to create, edit and manage evaluation criteria and rules for which content navigation requests are to be controlled using the redirection/navigation control process 116.

According to embodiments, upon receiving a selection of the create rule link 321 in the rules manager 300, the rule creator 400 is launched as a dialog box or modal window partially overlaying the rules manager 300. In other embodiments, the rule creator 400 is displayed in response to detecting a selection of the Add Rules link 911 in the action pane 906 of the configuration manager 900 shown in FIG. 9.

As shown in FIG. 4, the rule creator 400 can be used to enter data fields 404, including, but not limited to, the browser name 332 for a new rule 323 being added, element 326, operator 328, value 330, browser 332, and behavior 434. In embodiments, the behavior 434 can be used to define an action or behavior for a rule 323 so that it will open a new tab, window, or session (e.g., a new browser runtime process 114) for the redirection browser 332 when the other data fields 404 of the rule 323 are satisfied. Once the desired data fields 404 for the new rule 323 are entered, an administrator or user can select, using an input device, the OK button 408 to save the new rule 323.

As shown in FIG. 5, in one embodiment, upon detecting a selection of the create rules link 321 in the rules manager 300, the rule creator 500 is launched. In alternative embodiments, the rule creator 500 is launched when a selection of a rules manager link 905 or an add rule link in the action pane 906 in the configuration manager 900 described below with reference to FIG. 9. If a new rule is being created as a result of an add rule selection being made in Actions pane 906 of the configuration manager 900, and dialog box 502 is displayed with information regarding rule data entry fields 504. In the exemplary embodiment of FIG. 5, the rule data entry fields 504 can be used to name, configure, and enable a newly-created rule. Rule data entry fields 504 represent an embodiment where additional rule attributes and conditions beyond those shown in FIGS. 3 and 4 can be selected and entered for new rules 323. Additional rule data entry fields 1104 are described below with reference to the rule editor 1100 shown in FIG. 11.

Once selections and changes for data fields 504 for a new rule 323 have been made, the administrator can click on the OK button 408 to confirm the rule attribute and condition selections and entries or click on a cancel button 510 to cancel creation of the new rule. As shown in FIG. 11, a rule editor 1100 can be used to edit attributes and conditions for existing rules 323.

To create a new rule 323, an administrator or user can click the Create Rule link 321 in the rules manager 300 to invoke the rule creators 400 or 500.

The data entry fields 404 and 504 represent exemplary attributes and conditions that can be set for rules 323. Data entry fields 404 and 504 shown in FIGS. 4 and 5 are described below.

Value—the value 330 field contains the string or integer to conditionally match in order for the redirection/navigation control process 116 to control content navigation and rendering.

Rule—The rule 323 selection can determine which browser-platform combination a redirection/navigation control process 116, such as Catalyst, can use to load and display requested content. An example of such content is a requested webpage value 330 matching at least one rule 323. Any configured rules 323 can be listed in this drop down. In an exemplary default configuration, there are no rules 323 available. To change, delete, or disable a given rule 323, an administrator can use a drop down list to select an existing rule 323 and save the configuration by selecting the OK button 408. In embodiments, rules 323 can be applied to an attempted navigation individually or in an aggregate as a rule set 536. For example, using the rule creator 500, an administrator can associate a rule 323 with a rule set 536 by selecting a name of an existing rule set from a rule set drop down menu or list. In one embodiment, new rules 323 are not associated with any rule set 536 and the rule set attribute is set to ‘No rule set’ by default.

Command File Name—In an embodiment, a redirection/navigation control process 116, such as Catalyst, can be used to launch other applications or execute commands when conditions of a rule 323 are met. For example, an administrator can simply enter the full path/location 538 including the file name (labeled as ‘Command File Name’ in FIG. 5) of an executable for a specified browser 332 or other application to launch when a rule 323 applies to an attempted navigation. The location 538 can also specify a file name for an operating system or application command to execute when conditions of a rule 323 apply to a content request. The location 538 field supports environment and system variables for a command file name of a specified browser application 110 and/or its platform.

Command Arguments—one or more command arguments 540 can be used in conjunction to provide the ability to launch web applications or execute commands in a specific browser and/or platform. The arguments 540 can be a delimited list (e.g., comma or semicolon delimited) of parameters and variables that are passed to the command indicated in the command file of the location 538. For example, an administrator can use the %1 variable as a command argument 540 to insert a requested URL into the command arguments. Examples of arguments 540 include parameters and launch flags needed to instantiate a specified browser-platform combination. For example, when used in conjunction with the location 538 and/or other settings and criteria, arguments 540

Block Navigation—Determines whether to allow or block navigation when certain conditions are met. By setting block navigation 542 to ‘Disallowed,’ an administrator can prevent requested content from being loaded by aborting or terminating navigation requests. In accordance with an embodiment, if multiple rules 323 apply to an attempted navigation or content request, any rule 323 with block navigation 542 set to ‘Disallowed’ will take precedence over other rules 323. That is, in cases where other conditions and attributes of a rule or rules 323 would otherwise allow requested content to be displayed in a specified browser, a block navigation 542 setting of ‘Disallowed’ will result in the attempted navigation being terminated. In one embodiment, a message is displayed in the user interface 112 indicating that navigation to the requested content is not allowed before the navigation is aborted. For example, when the block navigation 542 field is set to ‘Disallowed’ and an attempted navigation is to be blocked, the location 538 may include a command file name of an executable that renders a dialog box displaying a message indicating that the requested content cannot be displayed. When block navigation 542 is set to ‘Allowed’ for a rule or rule(s) 323 applicable to an attempted navigation, redirection of the navigation proceeds in accordance with other attributes and conditions of the rule(s) 323.

Security level—According to an embodiment, a security level 544 can be established for a rule 323 or a set of rules 323. According to an embodiment, the redirection/navigation control process 116 can isolate requested content rendering and provides content loading behaviors in a secure manner. In one embodiment, the default security level is Medium. In embodiments, when the security level 544 is Medium or High, the redirection/navigation control process 116 will render only content matched by a rule 323 and navigation or requests for unmatched content will be cancelled/aborted. In another embodiment where the security level is Low, requested content not matching a rule 323 is rendered in the default/standard browser application 110 for a given client device 100. Table 3 below provides descriptions of the available security levels.

TABLE 3
security levels

| Security | |
|---|---|
| Level | Description |
| Low | Attempted navigation or requested content is considered |
| | to match a rule 323 based on a location, such as a value |
| | in the Address Bar of a browser application 110, instead |
| | of being based on each page element's unique (URI). If |
| | the content of the Address Bar matches a rule, the |
| | requested content, including all objects on a requested |
| | web page will be rendered using the specified browser- |
| | platform combination. The redirection/navigation control |
| | process 116 will not evaluate subsequent navigation |
| | events (e.g., clicking a link, etc.) and will continue to |
| | render requested content using the same browser- |
| | platform combination until the tab is closed. |
| | Note: This setting should be used judiciously. Since |
| | navigation events may not be consistently evaluated, |
| | use of this setting could potentially result in an |
| | enterprise's network or systems being exposed to |
| | security threats if malicious content is accessed. |
| | This can be the default value for the security level |
| | setting. |
| Medium | Requested content is considered to match a rule based |
| | on the value in the Address Bar (not based on each |
| | page elements unique URI). If the content of the |
| | Address Bar matches a rule, all objects on the |
| | requested page will be rendered using the specified |
| | browser-platform combination. The |
| | redirection/navigation control process 116 will treat |
| | subsequent navigation requests (e.g., clicking a link) as |
| | ‘new’ navigations and perform a complete evaluation of |
| | the requested content. |
| High | Requested content (individual page elements) is loaded |
| | only when a rule is matched. For example, if the |
| | requested content indicated in the Address Bar of a |
| | monitored browser application 110 matches a rule 323, |
| | all objects on the page will be evaluated (and rendered |
| | using a rule-specified browser) if the specific object |
| | matches as well) in accordance with applicable rules |
| | 323, the redirection/navigation control process 116 will |
| | treat subsequent navigation attempts and content |
| | requests (e.g., clicking a link, etc.) as ‘new’ navigation |
| | attempts and perform a complete evaluation of the |
| | requested content. |

In one embodiment, new rules 323 are set to a Medium security level 544 by default.

Browser Architecture

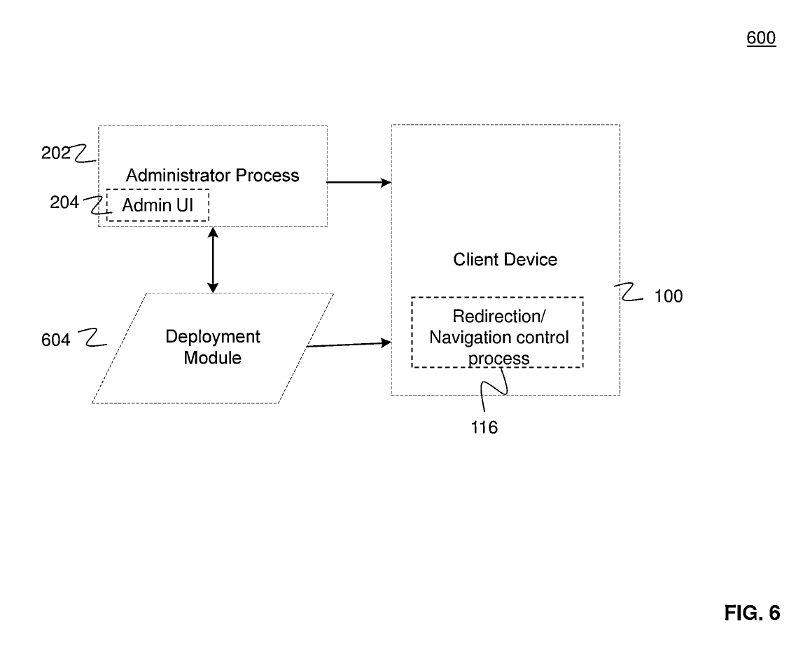

FIG. 6 depicts an exemplary browser architecture 600 in a hierarchal form. FIG. 6 is described with continued reference to the embodiments illustrated in FIGS. 1-5. However, FIG. 6 is not limited to those embodiments.

As shown in FIG. 6, browser architecture 600 includes administrative and management components comprising the administrative process 202 and its included administrative UI 204. The administrative and management components communicate with client device 100. Example user interfaces that make up the administrative UI 204 are described above with reference to FIGS. 3-5 and below with reference to FIGS. 9-11. As shown in FIG. 6, browser architecture 600 includes the redirection/navigation control process 116, which can be hosted by the client device 100. The browser architecture 600 further comprises a deployment module 604 that performs bidirectional communication with the administrative process 202 as the redirection/navigation control process 116 for the browser application 110 is configured (i.e., by an administrator). Based on the information received from the administrative process 202, the deployment module 604 communicates with the client device 100 and/or a server 140 to convey data, such as, but not limited to, executable files for a user interface 112 and the redirection/navigation control process 116, a default browser, rules 323 to be stored in a local rules and content database 118 or a rules and content database 144, local settings, and a local group policy, to the client device 100 or a server 140.

In accordance with embodiments, the hierarchy and organization of data conveyed by the deployment module 604 is as follows:

One or more files for an installer program for the redirection/navigation control process 116 are conveyed to a target server 140 or client device 100 where the redirection/navigation control process 116 and its rules engine and controller engines 208 and 210 and browser controllers 212 are to be installed. Although server 140 is depicted in FIG. 1 as hosting a web server 142, is it to be understood that server-side or manager components of the redirection/navigation control process 116 can be installed on enterprise servers that do not host a web server 142.

The deployment module 604 can convey files needed to install for a user interface 112 and client components of the redirection/navigation control process 116 to client devices 100. For example, the deployment module 604 can convey installer files needed to install the user interface 112, one or more browser applications 110, and a client-side redirection/navigation control process 116. Such client components can include common files, installation files for a redirection/navigation control process 116 to be installed on the client device 100, extension helper 220 files (e.g., +ExtHelper NPAPI Project files), browser extension 222 files for one or more browser applications 110, and non-browser information, such as any rules 323 to be added to the local rules and content database 118 on the client device 100.

### Method Embodiments

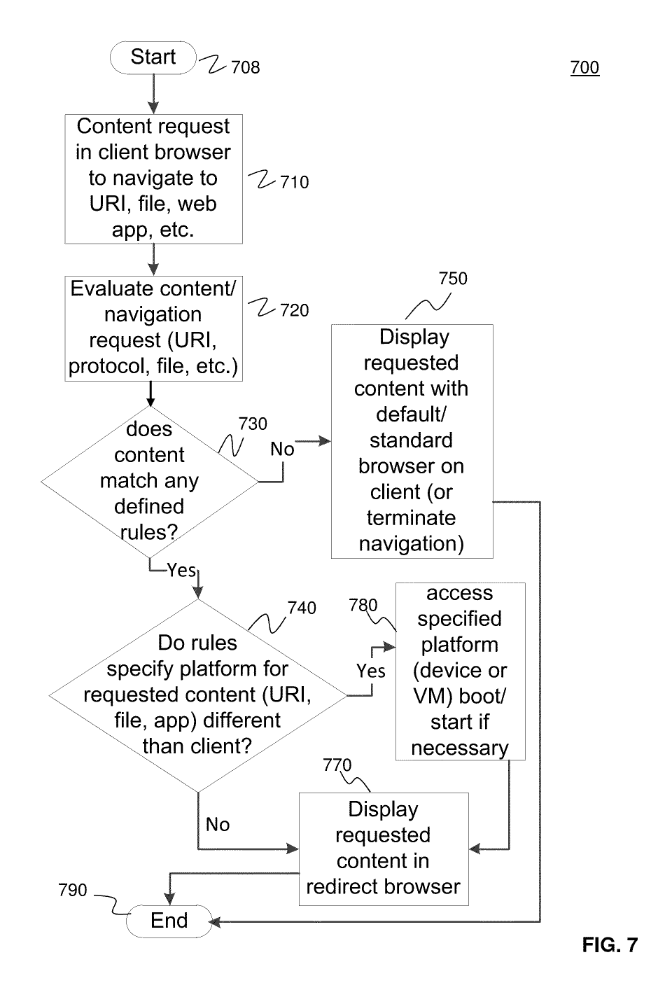

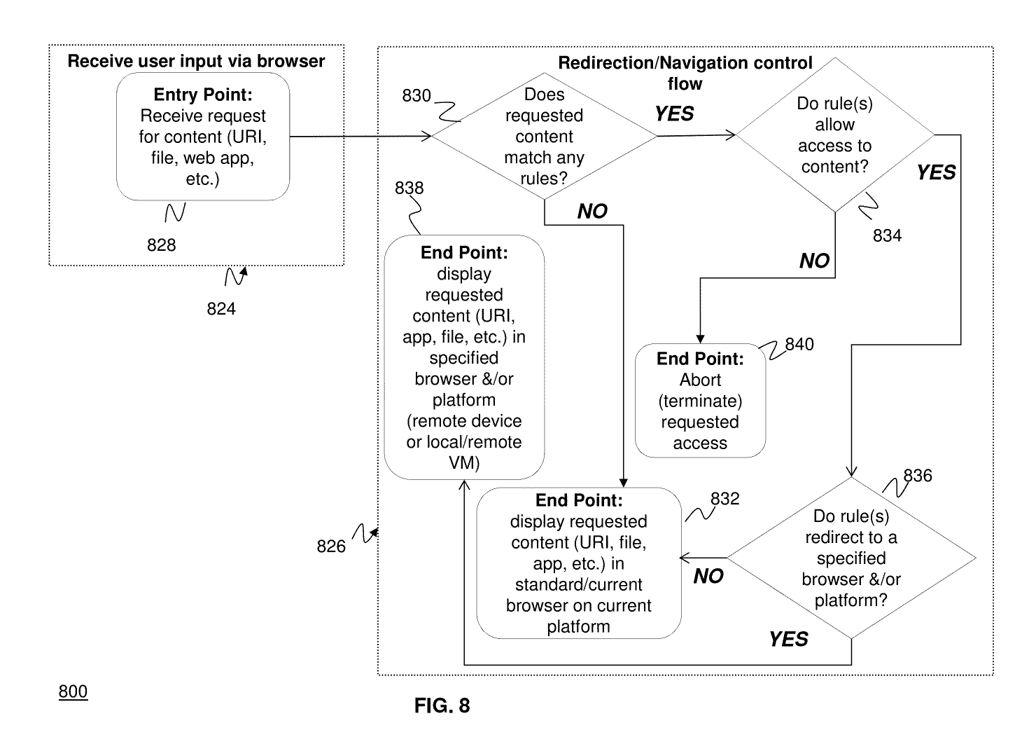

FIGS. 7 and 8 are flowcharts illustrating exemplary methods for controlling navigation of a browser application running on a client device to redirect the navigation to alternative browser applications and browser-platform combinations. The steps of the browser redirection and navigation control methods shown in FIGS. 7 and 8 do not necessarily have to occur in the order described. Further, as described below, some of the steps are optional.

FIG. 7 is a flowchart embodying a method for controlling navigation of a browser application running on a client device to redirect the navigation to alternative browser applications.

FIG. 7 is described with continued reference to the embodiments illustrated in FIGS. 1-6. However, FIG. 7 is not limited to those embodiments. As can be seen in FIG. 7, an embodiment includes a system configured to implement a computer implemented method 700 for using the redirection/navigation control process 116 to control navigation of a browser application 110 running on a client device 100 by redirecting the navigation to alternative browser applications or aborting/terminating navigation to requested content based on rules 323 applied by a rules engine 208.

Method 700 begins in step 708. In an embodiment, this step comprises monitoring browser applications for navigation attempts and content requests and intercepting such attempts and requests. The navigation attempts could occur on any browser application 110 or web client that the Browsium Catalyst product, or other embodiments disclosed herein are configured to monitor and intercept as part of step 708. After intercepting a navigation attempt or content request, control is passed to step 710.

In step 710, an attempted user navigation or request for content such as a URL (either local or external content) is received. As shown in FIG. 7, the content request received in step 708 can be a request in a browser application 110 to navigate to a URI, file, web application or other resources such as web pages. The attempted navigation can be a resource request identified by a uniform resource locator (URL) and step 708 can comprise intercepting navigation to the resource located by the URL. After the content request is received, control is passed to step 720.

In step 720, properties of the requested content, such as a resource located by a URL, are evaluated so that the applicability of any rules 323 can be determined in step 730. As seen in FIG. 7, step 720 can comprise evaluating a content/navigation request by examining the requested URI, the protocol (e.g., HTTP, HTTPS, FTP, etc.) and file properties. Properties of the URL can represent a number of identifiable markers corresponding to the resource or address of that resource. For instance, these properties can be related to the string representation of the URL (or parts thereof); they may be related to headers, server codes, or other information related to the transfer of the resource identified by the URL; they may be related to the contents of the resource identified by the URL; or they may be related to any number of other factors, metadata, content, etc. pertaining to the URL, the resource itself, the communication of said resource, or the loading of said resource. After the evaluation of the requested content is complete, control is passed to step 730.

In step 730, a determination is made to determine if the requested content matches one or more defined rules 323. In an embodiment, step 730 is performed by the rules engine 208. In cases where more than one rule 323 matches the content, the matching rules 323 can be evaluated by the rules engine 208 in a specified order. Such ordering or prioritization of rules 323 can be set using the administrative UI 204 (see, e.g., the configuration manager 900 shown in FIG. 9). If there is no match to a defined redirection/navigation control rule 323 based on the content properties discussed above with reference to step 720, control is passed to step 750. If the requested content matches one or more rules 323, control is passed to step 740.

In step 750, the requested content is rendered and displayed by a default browser application 110 and control is passed to step 790 where the method ends. In an alternative embodiment shown in FIG. 7, if the requested content does not match any defined rule 323, step 750 terminates the attempted navigation and control is passed to step 790 where the method ends. A default option to terminate or abort navigation to content not matching any defined rule 323 can be set as a heightened security level of the redirection/navigation control process 700. A lower security level can allow default navigation to content not matching any defined rule 323. The security level can be set via the administrative UI 204 and applied by the controller engine 210.

In step 740, a determination is made to determine if a particular platform (i.e., a redirect platform) specified by the matching rule(s) 323 identified in step 730 differs from the platform the content request was received from in step 710. Step 730 can be performed by the rules engine 208 in conjunction with the controller engine 210 to compare a platform of a client device 100 that a request for content originated from the rule(s) 323 matching the content. If the redirect platform differs from the client device 100 platform that the content request originated from, control is passed to step 780. If no platform is specified in the matching rule(s) 323 or if the platform of the client device 100 matches the redirect platform specified in the matching rule(s) 323, control is passed to step 770.

In step 770, the content requested in step 710 and evaluated in step 720 is displayed in the browser application 110 specified in the matching rule(s) 323 identified in step 730. After the requested content is displayed, control is passed to step 790 where the method 700 ends.

In step 780, the redirect platform specified in the matching rule(s) 323 is accessed. As shown in FIG. 7, this step can comprise accessing the redirect platform on a physical computing device or a VM. In an embodiment, the physical device can be any enterprise computing device accessible from the client device 100 via the network 130. According to embodiments, a VM for the redirect platform may be booted and started locally on the client device 100 or on an external device as needed. For example, step 780 can comprise launching and/or accessing a VM using commercially available virtualization solutions such as CITRIX™ XenServer, CITRIX™ VDI-in-a-Box, CITRIX™ XenApp, CITRIX™ XenDesktop, MICROSOFT™ Remote Desktop Services, MICROSOFT™ Terminal Services, VMWARE™ Player, MICROSOFT™ VirtualPC, SUN™ VirtualBox, VMWARE™ ESX/ESXi, MICROSOFT™ Hyper-V, PARALLELS™, and others.

After the redirect platform is accessed, control is passed to step 770 to display the requested content on the redirect platform with a browser application 110 specified in the matching rule(s).

FIG. 8 is a flowchart 800 illustrating operational steps by which presently disclosed browser redirection/navigation control process 116 enables control of and navigation of a browser application running on a client device 100 redirect the navigation to other browser applications.

FIG. 8 is described with continued reference to the embodiments illustrated in FIGS. 1-7. However, FIG. 8 is not limited to those embodiments.

As shown in FIG. 8, the steps of flowchart 800 are performed in response to a user input 824 in a browser application 110, which triggers the illustrated redirection/navigation control flow 826.

The Entry Point of flowchart 800 is in step 828 where a user enters a request to navigate to content such as a URL or search query in a browser application 110 or other user interface 112 of an application running on a client device 100. The user interface 112 can be a UI for an enterprise application such as an email client application containing hyperlinks to files, web pages or web applications. In accordance with an embodiment, this step can comprise monitoring applications and any browser applications 100 running on client devices 100 in an enterprise and intercepting attempted navigations and content requests originating from the monitored applications. After the navigation attempt or content request is received, control is passed to step 830 where the redirection/navigation control flow 826 begins.

In step 830, the attempted navigation or content request is evaluated against a set of rules 323 to determine if it matches any defined rule 323. If it is determined that the requested content matches one or more defined rules 323, control is passed to step 834. In one embodiment, step 830 is performed by the rules engine 208. In scenarios where more than one rule 323 matches the content requested in step 828, the matching rules 323 can be evaluated by the rules engine 208 in a specified sequence, which can be set using the administrative UI 204. If there is no match to a defined rule 323 to the requested content, control is passed to end point 832.

In step 832, the requested content is displayed/rendered by a default browser application 110.

In step 834, a determination is made as to whether the matching rule(s) 323 allow the requested content to be accessed. This step can be performed by the rules engine 208 in conjunction with the controller engine 210. If it is determined that access to the requested content is allowed by the matching rule(s) 323, control is passed to step 836. If it is determined that access to the requested content is prohibited and should be blocked pursuant to the matching rule(s) 323, control is passed to end point 840 where navigation to the requested content is aborted. In an embodiment, a message can be displayed in the browser application 110 on the client device 100 indicating that the navigation has been terminated due to enterprise policies embodied in matching rule(s) 323, security level 544, settings, or other criteria.

In step 836, a determination is made as to whether the matching rule(s) 323 specify redirection to another browser application 110 and/or platform that differs from the browser application 110 and platform of the client device 100 the request was received from in step 828. If it is determined that the matching rule(s) 323 indicate that the requested content is to be redirected to a specified browser application 110 and/or platform, control is passed to end point 838, where the content is displayed by a rendering engine of the specified browser application 110 on a specified platform, if any platform was specified in the matching rule(s) 323. If it is determined that the matching rule(s) 323 do not indicate that the requested content is to be displayed in a non-standard browser application 110 and/or platform, control is passed to end point 832, where the requested content is displayed/rendered by a default browser application 110 and the method shown in flowchart 800 ends.

In step 838, any redirect platform specified determined in step 836 is booted as needed and accessed so that the specified browser can be launched on the platform. Embodiments of step 838 comprise accessing a redirect platform on a physical computing device or a VM. For example, a redirect platform accessed in this step can be any physical enterprise computing device matching the specified platform that is accessible from the client device 100 via the network 130. Also, for example, step 838 can comprise accessing a VM for the redirect platform. As shown in FIG. 8, step 883 can also include booting the VM either locally on the client device 100 or on an external device as needed. In certain embodiments, step 838 can comprise launching and/or accessing a VM using virtualization solutions such as, but not limited to, CITRIX™ XenServer, MICROSOFT™ Remote Desktop Services, MICROSOFT™ Terminal Services, VMWARE™ Player, MICROSOFT™ VirtualPC, SUN™ VirtualBox, VMWARE™ ESX/ESXi Server, MICROSOFT™ Hyper-V, and PARALLELS™.

Example Configuration Manager Interface

FIGS. 9-11 depict an example graphical user interface (GUI) for configuration management of the presently disclosed browser redirection and navigation controller. FIGS. 9-11 are described with continued reference to the exemplary embodiments illustrated in FIGS. 1-8. However, FIGS. 9-11 are not limited to those embodiments.

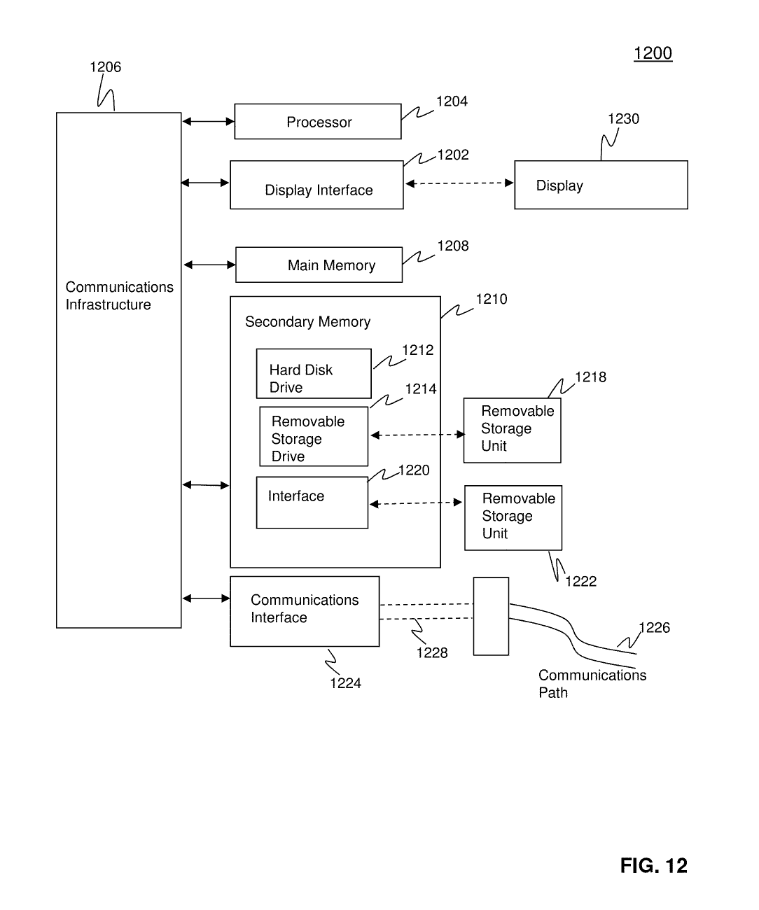

In embodiments, a client device 100 or a server 140 may include the exemplary interface illustrated in FIGS. 9-11. As with the rules manager interfaces described with reference to FIGS. 3-5 above, the interfaces shown in FIGS. 9-11 are typically launched by the administrative process 202 and accessed by an administrator via the administrative UI 204. According to one embodiment, a client device 100 running the browser application 110 with a browser redirection and navigation controller 116 may display the exemplary interface illustrated in FIGS. 9-11 as part of user interface 112. Throughout FIGS. 9-11, displays are shown with various hyperlinks, command regions, panes, tabs, buttons, drop down menus, dialog boxes, and data entry fields, which are used to initiate action, invoke routines, enter data, view data, or invoke other functionality, such as editing settings, browsers 332 and rules 323 for a browser redirection/navigation control process 116. For brevity, only the differences occurring within the figures, as compared to previous or subsequent ones of the figures, are described below. By using an input device (not shown) or touch screen display, which can be an exemplary implementation of the display 1230 shown in FIG. 12, on a client device 100 or server 140, an administrator or user can interact with the interface illustrated in FIGS. 9-11 to configure and manage settings and rules 323 for the browser redirection and navigation controller 116.

FIG. 9 depicts an exemplary interface for configuring overall settings for a browser redirection/navigation control process 116. In particular, FIG. 9 shows a configuration manager 900 with an Objects pane 904, an Actions pane 906, and a content pane 907. The configuration manager 900 can be used to modify settings (shown as data entry fields 919 in FIG. 9) and create and edit redirection browsers 332 and rules 323. The Objects pane 904 can include a selectable list of setting, browser 332, rule set 536, and rule 323 objects. In the example shown in FIG. 9, the Objects pane 904 allows selection of a settings link 909 to view and edit settings for the Catalyst embodiment of a browser redirection and navigation controller 116 application. The Objects pane 904 can also be used to select browsers 332 and rules 323 for editing.

As shown in FIG. 9, the content pane 907 can be context sensitive such that it includes data entry fields corresponding to the object(s) currently selected in the Objects pane 904. For example, the configuration manager 900 can be used to invoke a settings manager 910 when the settings link 909 is selected in the Objects pane 904. In the exemplary embodiment depicted in FIG. 9, the settings manager 910 displays editable settings fields 919 such as, a port, Override Default, and Default Browser in the content pane 907. In one embodiment, the port and Default Browser settings fields 919 are used to set the standard/default port and browser application 110 for an organization or enterprise. In the embodiment shown in FIG. 9, the Override Default settings field 919 can be set to true or false to indicate whether the default browser or other criteria will override browser rules 323. In the exemplary embodiment depicted in FIG. 9, the Default Browser settings field 919 is a drop down menu that can be used to select one of the browsers 332 listed in the Objects pane 904 as the default or standard browser application 110 for an enterprise. An exemplary GUI for a settings management tool is described in International Patent Application No. PCT/US2012/29031 entitled “Methods and Systems for One Browser Version to Use a Rendering Engine of Another Browser Version for Displaying Information,” filed Mar. 14, 2012, which is incorporated herein in its entirety.

The content pane 907 can display a list of rule data fields for a selected rule 323 that a redirection/navigation control process 116, such as Catalyst, can use to determine how to handle web application rendering. The rule data fields apply to the selected rule 323 in the Objects pane 904. The heading for each column in the content pane 907 refers to a specific rule attribute (e.g., name 324, set rule 325, value 330, etc.) for a given rule 323.

In accordance with embodiments, the Actions pane 906 includes a set of context sensitive GUI elements, dialog boxes, or information based on current activity in the content pane 907. For example, if a rule 323 or rule set 536 is selected in the Objects pane 904, the content pane 907 can display data fields for a rule 323 and the Actions pane 906 displays one or more of the Add Rule link 911, the Delete Rule link 912, the Move Rule Up link 924, and the Move Rule Down link 916. Using these links in the Actions pane 906 in conjunction with selections made in the content pane 907 of the configuration manager 900, an administrator or user can add, edit, manage or remove a rule 323. According to embodiments, to create a new rule 323, an administrator or user can click the Add Rule link 911 in the Actions pane 906 to display the rule creators 400 or 500 described above with reference to FIGS. 4 and 5. In an embodiment, when no rules 323 are present, the Objects pane 904 will display an empty rule set 536 and the Actions pane 906 only displays an active Add Rule link 911. As rules 323 are added, the Actions pane 906 displays additional links to manage rule 323 ordering, deletion, and editing. In another embodiment, when no rules 323 have been created, the Actions pane 906 displays an active Add Rule link 911 with a disabled Delete Rule link 912, Move Rule Up link 924 and Move Rule Down link 916. As rules 323 are added, the Actions pane 906 will display active links to manage ordering and deletion of rules 323. For example, when only a single rule 323 has been created in a rule set 536, the Delete Rule link 912 is displayed and enabled in the Actions pane 906 in addition to the Add Rule link 911. In accordance with embodiments, disabled, inactive links and other GUI elements can be displayed as greyed out or not displayed at all in the Objects pane 904, content pane 907, and Action pane 906.

When two or more rules 323 have been created, the Move Rule Up link 924 and Move Rule Down link 916 are activated and displayed in the Actions pane 906. In accordance with embodiments, rule ordering using the Move Rule Up link 924 and Move Rule Down link 916 can be established as a strict sequence, a hierarchy based upon prioritization or rule sets 536, or according to security levels 544 assigned to rules 323. If no rule sets 536 have been created and/or no rules 323 have been associated with a rule set 536, all rules 323 can be ordered relative to each other using the Move Rule Up link 924 and Move Rule Down link 916. For example, the content pane 907 can display a prioritized or sequential list of rules 323 that a redirection/navigation control process 116, such as Catalyst, can use to determine how to redirect and control navigation. When multiple rules 323 have been created that apply to a given content request, their application can be ordered and/or prioritized using the configuration manager 900. In an embodiment, rules 323 are executed in sequence starting with the rule 323 appearing first in a list of rules 323 (i.e., at the top of a vertically oriented list or in the left-most position of a horizontally oriented list) in the content pane 907 and ending with the last rule 323 listed (i.e., at the bottom of a vertically oriented list or in the right most position of a horizontally oriented list). In another embodiment, the relative priority of rules is based on the relative position of rules 323 in the content pane 907 such that rules 323 have a higher priority the closer they are to the beginning of the list. According to this embodiment, a higher priority rule 323 that overlaps with lower priority rules 323 will be applied instead of the lower priority rules 323. In one embodiment, rule sequencing and prioritization is accomplished using drag and drop operations in the content pane 907. For example, relative positions of rules 323 in a list or rule set 536 can be changed by selecting, using an input device, one or more rules 323 in the content pane 907, and dragging and dropping the selected rules 323 to move them higher or lower in the list of rules 323 in the content pane 907. In an alternative embodiment, reordering of rule sequences or priorities is performed by using the Move Rule Up link 924 and Move Rule Down link 916 in the Actions pane 906 for one or more rules 323 selected in the content pane 907. While all existing rules 323 can be organized into a sequences or prioritized list, only rules with their set rule field 325 selected (i.e., set to true or Enabled) are applied to an attempted navigation or content request.

FIG. 10 illustrates an interface for a browser manager comprising interfaces for a browser editor 1000 and a browser creator 1010. In the embodiment of FIG. 10, the browser editor 1000 displays data entry fields in the content pane 907 for an existing browser 332 selected in the Objects pane 907. As shown in FIG. 10, the browser editor 1000 can be used to modify a name of an existing browser 332, an install location 538, and/or any arguments/arguments 540 to be used when launching a runtime browser process 114 for a browser application 110 corresponding to the browser 332. In the example shown in FIG. 10, the install path 538 is a path name where the command file for the browser 332 was installed.

In accordance with embodiments, the browser creator 1010 shown in FIG. 10 can be displayed as a dialog box or modal window upon receiving a selection of an ‘add new browser’ value from a drop down menu displayed when a user right clicks a browser 332 for an existing rule 323 in the rules manager 300. In another embodiment, in response to receiving a selection of an ‘add new browser’ value or the in a drop down menu for the browser 332 data field 404 in the rule creator 400, the browser creator 1010 is launched as a dialog box. In yet another embodiment, the browser creator 1010 is launched as a modal or child window partially overlaying the parent configuration manager 900 interface when an ‘add new browser’ option is selected from a context-sensitive menu in the Objects pane 904. For example, the browser creator 1010 can be rendered when a user right clicks on a browser 332 in the Objects pane 904 and selects an ‘add new browser’ menu choice for the list of browsers 332. Alternatively, the browser creator 1010 can be invoked when an ‘add new browser’ menu choice is selected in the File menu of the configuration manager 900.

In the exemplary embodiment of FIG. 10, the browser creator 1010 displays data entry fields for a new browser 332 to be added. As shown in FIG. 10, the browser creator 1010 can be used to enter a name of a new browser application 110 to be added along with an install location 538 for the browser executable and any arguments 540 to be used when launching a runtime browser process 114 for the browser application 110 corresponding to the browser 332. In the example shown in FIG. 10, the location 538 is a fully qualified path name and includes the command file name for the new browser 332 being added.

FIG. 11 illustrates an exemplary interface for a rule editor 1100. As URIs, URLs, and other rule values 330 can be complex, and complexity may lead to typographical errors, in the event an administrator makes a mistake or need to revise a rule 323, the rule editor 1100 can be invoked. The rule editor 1100 can comprise part of the administrative UI 204 to display existing information for particular rule data entry fields 1104 that can be edited by a user or administrator for a previously-created rule 323.

In one embodiment, the rule editor 1100 can be invoked when the edit rule link 322 is selected in the rules manager 300 and is displayed as a dialog box or modal window that is a child window of the rules manager 300. In another embodiment, the rule editor 1100 is launched when a rule 323 is selected in the Objects pane 904 of the configuration manager 900. In the exemplary embodiment shown in FIG. 11, upon receiving a selection of an existing rule 323 in the Objects pane 904 of the configuration manager 900, rule data entry fields 1104 for attributes and conditions of the selected rule 323 are displayed in the content pane 907. When a particular data entry field 1104 is selected for editing in the content pane 907, a description 1110 can be displayed with information regarding the selected field 1104.

The rule data entry fields 1104 include attributes and settings for rules 323 shown in FIGS. 3 and 4 and also include drop down menus to edit select a start browser 1112, a start action 1114, and a focus 1116. As shown in FIG. 11, the start browser 1112 can be set to ANY in cases where the redirection rule 323 is to be applied to an attempted navigation from any browser 332. The start browser 1112 can also be set to a specific browser 332, such as an enterprise's default/standard browser entered in the Default Browser settings field 919 in the settings manager 910, so that the rule 323 will be applied to navigation attempts and content requests starting/originating from the default browser. The start browser 1112 can also be set to another browser 332 that is monitored by the browser redirection/navigation control process 116. In some cases, the start browser 1112 may be the same browser application 110 as the redirection browser 332 (labeled as the ‘End browser’ in FIG. 11). In these cases, while the start and redirection/end browsers 1112 and 332 may be the same application (e.g., Firefox or Chrome), additional criteria and settings can redirect the navigation to launch the browser 332 on another platform. For example, the location 538 and parameters/arguments 540 for the browser 332 can indicate that the browser 332 is located on another machine (physical or virtual).

With continued reference to FIG. 11, the start action 1114 can be set to ‘Same page’ when the rule 323 being edited is to be applied to a navigation attempt originating from the same web page that a rule 323 is redirecting the navigation to. As shown in FIG. 11, a start action 1114 can be set to ‘Same page’ in order to apply a rule 323 to an attempted navigation originating from the same web page indicated in the value 330 attribute (e.g., <http:/www.gmail.com>). The focus 1116 can be set to ‘End Browser’ in cases where an administrator wants the redirection/end browser 332 to be active and selected to receive input in a user interface 112 after the rule 323 is applied to an attempted navigation. The focus 1116 can be set to ‘Start Browser’ if the focus is to be returned to the start browser 1112 after the rule is applied. In addition to setting the redirect browser 332 and focus 1116, the behavior 434 (labeled as ‘End Action’ in FIG. 11) for the rule 323 can be set. As seen in FIG. 11, the behavior 434 can be set to ‘New tab’ when an administrator wishes to have the End browser 332 open the requested content in a new tab.

Example Computer System Implementation

Although exemplary embodiments have been described in terms of methods, systems, and architectures, it is contemplated that certain embodiments may be implemented by microprocessors of a computer, such as computer system 1200 illustrated in FIG. 12. In various embodiments, one or more of the functions of the various components may be implemented in software that controls a computing device, such as the example computer system 1200 described below with reference to FIG. 12. The processor(s) of the computer system 1200 can be configured to execute software and program instructions recorded on a non-transitory computer-readable recording medium, such as a hard disk drive, ROM, flash memory, optical memory, or any other type of non-volatile memory.

Aspects of the present disclosure shown in FIGS. 1-11, or any part(s) or function(s) thereof, may be implemented using hardware, software modules, firmware, tangible computer readable media having instructions stored thereon, or a combination thereof and may be implemented in one or more computer systems or other processing systems.

FIG. 12 illustrates an example computer system 1200 in which embodiments of the present disclosure, or portions thereof, may be implemented as computer-readable code. For example, the client device 100, the browser application 110, the browser redirection/navigation control process 116, the server 140, the web server 142, and the architectures of FIGS. 1, 2 and 6, can be implemented in the computer system 1200 using hardware, software, firmware, non-transitory computer readable media having instructions stored thereon, or a combination thereof and may be implemented in one or more computer systems or other processing systems. Hardware, software, or any combination of such may embody any of the modules and components used to implement the system components and architectures of FIGS. 1, 2, and 6. Similarly, hardware, software, or any combination of such may embody modules and components used to implement the methods of FIGS. 7 and 8 and graphical user interfaces (GUIs) depicted in FIGS. 3-5 and 9-11.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, at least one processor device and a memory may be used to implement the above described embodiments. A processor device may be a single processor, a plurality of processors, or combinations thereof. Processor devices may have one or more processor cores.

Various embodiments of the present disclosure are described in terms of this example computer system 1200. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1204 may be a special purpose or a general purpose processor device. As will be appreciated by persons skilled in the relevant art, processor device 1204 may also be a single processor in a multi-core/multiprocessor system, such system operating alone, or in a cluster of computing devices operating in a cluster or server farm. Processor device 1204 is connected to a communication infrastructure 1206, for example, a bus, message queue, network, or multi-core message-passing scheme.

The computer system 1200 also includes a main memory 1208, for example, random access memory (RAM), and may also include a secondary memory 1210. Secondary memory 1210 may include, for example, a hard disk drive 1212, removable storage drive 1214. Removable storage drive 1214 may comprise a floppy disk drive, a magnetic tape drive, an optical disk drive, a flash memory, or the like.

The removable storage drive 1214 reads from and/or writes to a removable storage unit 1218 in a well-known manner. Removable storage unit 1218 may comprise a floppy disk, magnetic tape, optical disk, etc. which is read by and written to by removable storage drive 1214. As will be appreciated by persons skilled in the relevant art, removable storage unit 1218 includes a non-transitory computer usable storage medium having stored therein computer software and/or data.

In alternative implementations, secondary memory 1210 may include other similar means for allowing computer programs or other instructions to be loaded into the computer system 1200. Such means may include, for example, a removable storage unit 1222 and an interface 1220. Examples of such means may include a program cartridge and cartridge interface (such as that found in video game devices), a removable memory chip (such as an EPROM, or PROM) and associated socket, and other removable storage units 1222 and interfaces 1220 which allow software and data to be transferred from the removable storage unit 1222 to the computer system 1200.

The computer system 1200 also includes a display interface 1202 that allows data to be transferred between the computer and a display 1230. Such data may include data to be displayed as part of a UI or GUI. In embodiments, the user interface 112 and/or the administrative UI 204 described above with reference to FIGS. 1, 2 and 6 can be rendered on the display 1230. The display 1230 can be a touch screen configured to accept input via user gestures or an input device (not shown) such as a stylus or other pointing device.

The computer system 1200 may also include a communications interface 1224. Communications interface 1224 allows software and data to be transferred between the computer system 1200 and external devices. Communications interface 1224 may include a modem, a network interface (such as an Ethernet card), a communications port, a PCMCIA slot and card, or the like. Software and data transferred via communications interface 1224 may be in the form of signals, which may be electronic, electromagnetic, optical, or other signals capable of being received by communications interface 1224. These signals may be provided to communications interface 1224 via a communications path 1226. Communications path 1226 carries signals and may be implemented using wire or cable, fiber optics, a phone line, a cellular phone link, an RF link or other communications channels. In this document, the terms ‘computer program medium,’ ‘non-transitory computer readable medium,’ and ‘computer usable medium’ are used to generally refer to media such as removable storage unit 1218, removable storage unit 1222, and a hard disk installed in hard disk drive 1212. Signals carried over communications path 1226 can also embody the logic described herein. Computer program medium and computer usable medium can also refer to memories, such as main memory 1208 and secondary memory 1210, which can be memory semiconductors (e.g., DRAMs, etc.). These computer program products are means for providing software to the computer system 1200.

Computer programs (also called computer control logic) are stored in main memory 1208 and/or secondary memory 1210. Computer programs may also be received via communications interface 1224. Such computer programs, when executed, enable the computer system 1200 to implement certain embodiments of the present disclosure discussed herein. In particular, the computer programs, when executed, enable processor device 1204 to implement the processes of the present disclosure, such as the stages in the methods illustrated by the flowcharts of FIGS. 7 and 8, discussed above. Accordingly, such computer programs represent controllers of the computer system 1200. Where the present disclosure is implemented using software, the software may be stored in a computer program product and loaded into the computer system 1200 using removable storage drive 1214, interface 1220, and hard disk drive 1212, or communications interface 1224.

Embodiments of the present disclosure also may be directed to computer program products comprising software stored on any computer useable medium. Such software, when executed in one or more data processing device, causes a data processing device(s) to operate as described herein. Embodiments of the present disclosure employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.), and communication mediums (e.g., wired and wireless communications networks, local area networks, wide area networks, intranets, etc.).

### CONCLUSION

It is to be appreciated that the Detailed Description section, and not the Summary and Abstract sections, is intended to be used to interpret the claims. The Summary and Abstract sections may set forth one or more but not all exemplary embodiments of the present disclosure as contemplated by the inventor(s), and thus, are not intended to limit the present disclosure and the appended claims in any way. Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the present disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

What is claimed is:

1. A computer implemented method for controlling navigation to content requested on a client device, the method comprising:
intercepting a request to navigate to content from an originating application on the client device;
evaluating the requested content against one or more navigation control criteria or rules to determine whether the requested content is to be displayed in a specified application and/or on a specified platform differing from the originating application and/or platform of the client device; and
in response to determining that the requested content matches at least one of the one or more criteria or rules, redirecting the navigation to a specified application and/or platform in accordance with the at least one matching criteria or rule.

2. The method of claim 1, wherein the redirecting comprises displaying the requested content in the specified application and/or on the specified platform, the method further comprising, in response to determining that the requested content does not match at least one of the one or more criteria or rules, displaying the requested content in the originating application on the client device.

3. The method of claim 1, wherein the evaluating further comprises evaluating the requested content against the one or more criteria or rules to determine whether navigation to the requested content is allowed; and
in response to determining that navigation to the requested content is not allowed, terminating navigation to the requested content.

4. The method of claim 3, further comprising, prior to the terminating, displaying a message in the originating application indicating that navigation to the requested content is prohibited.

5. The method of claim 1, wherein the intercepting comprises:
monitoring the originating application; and
receiving a request to navigate to the requested content from the monitored originating application.

6. The method of claim 5, wherein the originating application is an enterprise application,
and wherein the content request is received as a result of a hyperlink selection in the enterprise application.

7. The method of claim 6, wherein the enterprise application is one of a word processing application, a database application, an e-mail application, a graphics application, a spreadsheet application, or another application capable of receiving a selection of content.

8. The method of claim 5, wherein the originating application is a browser application on the client device and the specified application is a different, specified browser application,
and wherein the content request is received as a result of an attempted navigation in the browser application on the client device to a web page, web application, or file identified by a uniform resource locator (URL).

9. The method of claim 8 wherein the evaluating comprises evaluating properties of the requested content located by a requested URL against the one or more criteria or rules to determine whether the attempted navigation is to be redirected to a specified browser application to process the URL request.

10. The method of claim 9, wherein the properties include one or more of an absolute URL, a domain, a protocol, a port, a user identification, or a string within the requested URL,
and wherein the protocol is one of a Hypertext Transfer Protocol (HTTP), an HTTP secure (HTTPS) protocol, and a File Transfer Protocol (FTP).

11. A computer readable storage medium having program instructions stored thereon for enabling control of navigation to content requested on a client device, the instructions comprising:
instructions for receiving and intercepting a request to navigate to content from an originating application on the client device;
instructions for evaluating the requested content against one or more navigation control rules to determine whether the requested content is to be displayed in a specified application and/or on a specified platform differing from the originating application and/or platform of the client device; and
in response to determining that the requested content matches at least one of the one or more rules:
instructions for redirecting the navigation to a specified application and/or platform in accordance with the at least one matching rule; and
instructions for displaying the requested content in the specified application and/or on the specified platform.

12. The computer readable storage medium of claim 11, wherein each of the one or more rules have a plurality of attributes including:
a name;
an element;
a value;
a reference to the specified application; and
one or more of an operator, a behavior for the specified application, and a specified platform for the specified application.

13. The computer readable storage medium of claim 12, wherein the originating application is a browser application and the specified application attribute is reference to a particular version of a specified browser.

14. The computer readable storage medium of claim 13, wherein the element attribute is one or more of: domain, absolute uniform resource identifier (URI), and display URI,
and wherein the value attribute is a regular expression or a string indicating a domain, a partial URI, or an absolute URI.

16. The computer readable storage medium of claim 13, wherein the operator attribute is one or more of: is, is not, less than, more than, begins with, ends with, excludes, includes, and regular expression (RegEx),
wherein the behavior attribute indicates that the requested content should be displayed by the specified browser by one or more of: opening a new browser tab, opening a new browser window, or starting a new browser session,
and wherein the specified platform attribute indicates:
an operating system (OS) of the specified platform; and
at least one computing device or virtual machine (VM) capable of running the OS, wherein the at least one computing device or VM is accessible from the client device.

17. The computer readable storage medium of claim 13, wherein the instructions for evaluating comprise instructions to retrieve the one or more rules from a rules data store.

18. A system capable of controlling navigation to content requested via an originating browser application on a client device, the system comprising:
a display module configured to present an interactive administrative user interface (UI) in a display, and receive, via the administrative UI, user input for creating, selecting, and editing a plurality of attributes for one or more navigation rules;
a browser controller configured to monitor and intercept a content request from the originating browser application;
a rules engine configured to evaluate properties of the requested content against one or more rules to determine that the requested content is to be displayed in a specified browser application; and
a controller engine configured to redirect navigation for the requested content to the specified browser application by invoking one of a plurality of browser controllers corresponding to the specified browser application,
wherein the one of the plurality of browser controllers is configured to communicate with an existing or newly instantiated browser process for specified browser application,
and wherein the display module is further configured to display the requested content in the specified browser application.

19. The system of claim 18, wherein the rules engine is further configured to retrieve changes made to rules in administrative UI via an Extensible Markup Language (XML) document or registry,
wherein the browser controller if further configured to:
receive an indication from the rules engine that the requested content matches at least one of the one or more rules; and
create the plurality of browser controllers, the plurality of browser controllers further comprising a client browser controller for the originating browser application and other browser controllers for browser applications being monitored by the system,
wherein each of the plurality of browser controllers comprise a server transport module configured to communicate with a browser process.

20. The system of claim 19, wherein the browser process comprises:
an extension helper;
a browser-specific extension; and
a client transport module in communication with a server transport module of browser controller for the browser process.
